(19) United States
(12) Patent Application Publication
(10) Pub. No.: US 2005/0131645 A1
(43) Pub. Date: Jun. 16, 2005

(54) Machine having automatic transport with scanning and GPS functions

(76) Inventor: Peter John Panopoulos, Hickory Hills, IL (US)

Correspondence Address: PETER J. PANOPOULOS, 9220 S. 87TH COURT, HICKERY HILLS, IL, 60457, US

(21) Appl. No.: 10/863,198

(22) Filed: Jun. 8, 2004

Related U.S. Application Data
(60) Provisional application No. 60/476,965, filed on Jun. 9, 2003.
(60) Provisional application No. 60/483,328, filed on Jun. 27, 2003.

(51) Int. Cl. G01C 21/28

(52) U.S. Cl. 701/214

(57) ABSTRACT

A automatic-transport system with scanning and GPS functions for moving people or objects, on platforms or items placed on an automatic-transport system that can be ejected from it and delivered from one location to another and to return automatically or to proceed to other destination(s) by following GPS coordinates, and or by following a line painted or taped to a floor through forward looking scanners built into the automatic-transport system. The automatic-transport system can arrive at a destination and give an alert when it has arrived. Electromechanical system(s) aboard the unit can drop off contents automatically at destinations and load or unload cargo. The transport unit can proceed from one location to another stored in its memory and or it may be redirected by its circuitry or remotely through a wireless port, or directed by GPS or radio control circuits to a further destination.

### CROSS REFERENCE TO RELATED APPLICATIONS

This application is based on provisional application Ser. No. 60/476965, filed on Jun. 9, 2003 and it is further based on provisional application Ser. No. No. 60/483328, filed on Jun. 27, 2003.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

1. Field of the Invention

The present invention relates generally to an automatic-transport system and more specifically it relates to an automatic-transport system advanced version 2 with added logic circuits and version models addressing further industries totaling at least (8) eight industries from the eight model versions being patented and protected from this application herewith with scanning and GPS functions for moving people or objects, including but not limited to pallets of items, boxes, cargo, drums, garbage cans, bins, manufactured parts from one cell to another, documents, mail, or other items through optional secure electromechanical transfer of contents from the automatic transport system to optional secure storage areas or bins, or secure mail, packages, documents, parts, supplies and or containers, tapes, media within corporate mail departments stops, mail routes, or rooms, or to secure containers for mail or other delivery to residential or business or industrial communities, or to deliver construction materials, chemicals, waste, hazardous materials, military supplies, radioactive materials, supplies, etc. on platforms or items placed on an automatic-transport system that can be ejected from it and delivered from one location to another and to return automatically or to proceed to other destination(s) by following GPS coordinates, and or by following a line painted or taped to a floor through scanners built into the automatic-transport system.

2. Description of the Related Art

It can be appreciated that automatic-transport system have been in use for years. Typically, automatic-transport system are comprised of fork lifts or hand-operated, and or manually-operated dollies for moving boxes or pallets around in a warehousing environment or from truck to designated areas, or garbage cans from one location of a plant to another or for moving other items around in a manufacturing or in an office environment, in mailrooms, or other environment(s) from one operating cell to another either by utilizing electromechanical transfer mechanisms, and or by manual means by offering space for manual operational access of employees, or not.

Existing products commonly found in the marketplace also do not use electromechanical means and or combustion means to move people utilizing scanner means and or GPS means to move cargo, garbage, or people from one location to another utilizing the same features as the present invention.

The main problem with conventional transport systems are that they do not provide an automated means for moving items from one location to another. Existing products also do not provide automated delivery at scheduled times. Existing products are not designed for convenience either. Existing products require employees and increase operational costs and they are prone to cause employee injuries and incur employee lawsuits costing companies millions of dollars. Existing products also allow increased room for accidents and errors and theft. Existing products do not alert the cell they come to automatically trigger an operation for the next desired step in the process, such as alerting the manager to unload the unit. Another problem with conventional automatic-transport system are that they do not automatically deliver and drop-off the contents of the automatic transport system and then return unattended to pick up the next load. Another problem with conventional automatic-transport system are that hand operated dollies and forklifts are not designed for mass deliveries and to lower operational costs. Furthermore, existing products such as forklifts and hand-operated dollies take longer to use than the proposed automated transport system, thus increasing operational costs.

While these devices may be suitable for the particular purpose to which they address, they are not as suitable for moving people or objects, including but not limited to pallets of items, boxes, cargo, drums, garbage cans, bins, manufactured parts from one cell to another, documents, mail, construction materials, chemicals, waste, hazardous materials, military supplies, radioactive materials, supplies, etc. on platforms or items placed on an automatic-transport system that can be ejected from it and delivered from one location to another and to return automatically or to proceed to other destination(s) by following GPS coordinates, and or by following a line painted or taped to a floor through scanners built into the automatic-transport system. The main problem with conventional automatic-transport system are they do not provide an automated means for moving items from one location to another. Existing products do not provide automated delivery at scheduled times. Existing products are not designed for convenience. Existing products require employees and increase operational costs. Existing products also allow increased room for accidents and errors. Existing products do not alert the cell they come to automatically trigger an operation for the next desired step in the process, such as alerting the manager to unload the unit. Another problem is that they do not automatically deliver and drop-off the contents of the automatic transport system and then return unattended to pick up the next load. Also, another problem is that hand operated dollies and forklifts are not designed for mass deliveries and to lower operational costs. Furthermore, existing products such as forklifts and hand-operated dollies take longer to use than the proposed automated transport system, thus increasing operational costs.

In these respects, the automatic-transport system with scanning and GPS functions according to the present invention substantially departs from the conventional concepts and designs of the prior art, and in so doing provides an apparatus primarily developed for the purpose of moving people or objects, including but not limited to pallets of items, boxes, cargo, drums, garbage cans, bins, manufactured parts from one cell to another, documents, mail, construction materials, chemicals, waste, hazardous materials, military supplies, radioactive materials, supplies, etc. on platforms or items placed on an automatic-transport system that can be ejected from it and delivered from one location to another and to return automatically or to proceed to other destination(s) by following GPS coordinates, and or by following a line painted or taped to a floor through scanners built into the automatic-transport system.

### BRIEF SUMMARY OF THE INVENTION

The primary object of the invention is to provide an automatic-transport system with scanning and GPS functions.

Another object of the invention is to provide an automatic-transport system for moving people or objects, including but not limited to pallets of items, boxes, cargo, drums, garbage cans, bins, manufactured parts from one manufacturing cell to another, documents, mail, construction materials, chemicals, waste, hazardous materials, military supplies, radioactive materials, supplies, etc., on platforms or items placed on the automatic-transport system that can be ejected from it and delivered from one location to another automatically.

Another object of the invention is to provide an automatic-transport system that can scan lines painted on a floor and follow them to a destination.

A further object of the invention is to provide an automatic-transport system that can follow GPS coordinates to a destination or to follow a route mapped out on a GPS controller.

Yet another object of the invention is to provide an automatic-transport system that can receive downloads of GPS coordinates to follow a programmed route.

Still yet another object of the invention is to provide an automatic-transport system that can mechanically load and or unload contents into and out of the automatic-transport system through the use of electromechanical mechanisms and or hydraulic and or pneumatic arms and linkages designed to grasp and load and unload objects into or out of the automatic-transport system.

Another object of the invention is to provide an automatic-transport system with electronic or combustible motors to propel the transport system from one physical location to another.

Another object of the invention is to provide an automatic-transport system with logic circuits that will enable it to arrive at a destination and trace its steps to return back by going in reverse or in an alternate mapped route through GPS coordinates fed to it or by following a painted or taped line on a floor of a warehouse or a factory or a driveway or street for example.

A further object of the invention is to provide an automatic-transport system with logic circuits having RF modulation receiving circuits and remote circuit operability and drive mechanisms to control the transport system in a manner to control and steer the transport system to and from designated route(s).

Yet another object of the invention is to provide an automatic-transport system with logic circuits having RF modulation receiving circuits and remote circuit operability to allow the automatic transport system to automatically open the “electronic garage door opener” said automatic transport system also having the logic and capability to be programmable to capture the frequency from a person's garage door transmitter in program mode that will allow it to open the garage door.

Still yet another object of the invention is to provide an automatic-transport system with logic circuits having the functionality so the automatic-transport system can be set through an additional built-in timer control circuit that keeps track of time and day of the week to allow the transport system to be set to open a residential garage door through a remote control transmission circuit at a specific time and date each week so that in garbage handling versions of the automatic-transport system a consumer may keep the automatic transport system in his or her garage loaded with a series of garbage cans, and on a specific programmed time and day each week the automatic-transport system can will open the garage door start itself up and travel down the driveway following a taped or painted line or by utilizing GPS coordinates travel to a garbage can drop-off location, then use its mechanical mechanisms to unload the garbage cans or bags, or items placed on the transport unit, then return to the garage unattended back to its lock-down docking position so it cannot be stolen; later, the user can press a manual button on the transport system and it will open the garage door unit and it will then travel out to the drop-off location to retrieve the garbage cans whereby the consumer can go with the unit and place the cans on the transport system and press a button and then the unit will take them back to the garage and dock and lock down and shut off.

Another object of the invention is to provide an automatic-transport system with logic circuits having the functionality so the automatic-transport system can be set through an additional built-in timer control circuit that keeps track of time and day of the week to allow the transport system to be set to activate the automatic transport system to go on a designated route at a certain time and date automatically without user intervention to deliver garbage from one location to another and drop it off or to just park and dock and lock down at a destination so the unit cannot be stolen and then return at a certain designated pre-programmed time either to deliver garbage so that garbage personnel can pick up the trash or to deliver cargo such as pallets or warehoused items suck as boxes or other goods, or manufactured goods from one manufacturing cell to another, or construction materials, radioactive materials, military supplies, and or other materials or items, or even people, in other commercial variations, of the present invention.

Another object of the invention is to provide an automatic-transport system with with logic circuits and mechanisms having the functionality that will allow the automatic-transport system to drop-off a lock-downable payload wagon that it locks-down to a lockdown pin when it drops off a delivery before leaving a payload at a programmed destination. Said automatic-transport system can then be programmed to leave the payload wagon and go back where it came from automatically and autonomously (unattended utilizing scanning or GPS means) and then come back to re-dock with the payload wagon and pick up the payload wagon it left behind by redocking with it and electronically “unlocking” it from the lockdown pin and then return with the payload wagon back to its original location.

A further object of the invention is to provide an automatic-transport system with logic circuits and transmission means that will keep the wheels from slipping including mechanisms that will allow an automated-transport system to lock its wheels as it is moving so as not to slide down a slope as it is moving things if the transport system is going up or down a gradient.

A primary object of the present invention is to provide an automatic-transport system with scanning and GPS functions that will overcome the shortcomings of the prior art devices.

An object of the present invention is to provide an automatic-transport system with scanning and GPS functions for moving people or objects, including but not limited to pallets of items, boxes, cargo, drums, garbage cans, bins, manufactured parts from one cell to another, documents, mail, construction materials, chemicals, waste, hazardous materials, military supplies, radioactive materials, supplies, etc. on platforms or items placed on an automatic-transport system that can be ejected from it and delivered from one location to another and to return automatically or to proceed to other destination(s) by following GPS coordinates, and or by following a line painted or taped to a floor through scanners built into the automatic-transport system.

Another object is to provide a automatic-transport system with scanning and GPS functions that will allow the movement of contents from one location to another electromechanically and or through other means employing a variety of engine means (including combustion and other engine or electromechanical motor means if desired) as desired in an automated transport system to move contents from one physical location to another.

Another object is to provide a automatic-transport system with scanning and GPS functions that will be an automated transport system that will arrive at a destination and alert a. manager or employee or both or other people electronically, or a consumer in consumer models to take further action, or to automatically trigger the cell it comes to unload the automated transport system utilizing electromechanical transfer system(s), and or to drop off contents automatically and return where the automatic transport system came from, or to await instructions from an employee to be sent back to where it came from.

Another object is to provide an automatic-transport system with scanning and GPS functions that will be wagon-like automated-transport system having at least three (3) or (4) four wheels per platform area or automated transport system. Where (1) or two (2) wheels of the automated-transport system will be used for steering the automated-transport system with auto-correction means to follow a path given to the automatic-transport system either through its scanners by following a taped or painted line on the ground, floor, pavement, asphalt highway, street, etc., or by following GPS information given or fed to the automatic-transport system through an electromechanical steering system controlled by a circuit designed to follow a line, no matter how it is drawn, in direction “X or Y”, forward or reverse, for length “Z” through scanners installed on the bottom and or the front/back, bottom, and or side(s) of the unit, and or by employing GPS coordinates and directions without the need for employing the use of lines and scanners, and where the other two wheels will be used for stability and to make it mobile.

Furthermore, another object of my invention is to provide a device that will allow an automated-transport system to lock its wheels as it is moving so as not to slide down a slope as it is moving things if the transport system is going up or down a gradient.

Another object is to provide an automatic-transport system with scanning and GPS functions that will be able to send people, cargo, warehouse items, manufactured items, supplies, mail, garbage, waste, recyclables, scrap, raw materials, or other items, automatically from one location to another that will have optional suspension means for every one of its wheels or its track or tread systems (if treads are used) for going over uneven terrain, curbs, logs, stones, steps, etc., when the automatic-transport system is in operation if following GPS coordinates on its path, or for when the automatic-transport system is following a taped line or a painted line on pavement or on flooring or asphalt or on the ground, or even if the automatic transport system has to climb or go up and down steps, over steps, through ditches, or over bumps over a variety of speeds.

Another object of the automatic-transport system is to provide the functionality to allow an automatic-transport system to deliver mail, or other supplies or parts to mail stop(s) in companies in an automated fashion by following taped lines or painted lines on the floor of a building or to go to designated areas through GPS coordinates while alerting a supervisor or an employee that mail or supplies or a part have come through a wireless port when the automatic-transport system has arrived with the mail or parts or supplies.

The automatic-transport system can either automatically disburse the parts or supplies or the mail to allow for automatic disbursement in a designated area for mail or supplies or items to be delivered or it can be set in secure mode. In secure scenarios, an employee or a supervisor is alerted through a wireless port through cell phone or remote computer means via email or other alert paging means that mail or a part or supplies have arrived at the designated area that a security code can be entered so someone can come and enter the code that the automatic transport system can be unlocked by a security code to access the secure contents once the automatic-transport system has arrived in the designated area. This functionality can apply to other versions of the automatic-transport system for delivering other items (not just mail). The receiver of the secure contents can then enter the secure code either to send the automatic-transport system back to the loading zone or to another specific location by entering a new destination zone into the automatic-transportation system's control panel or by entering resume operation to send it on it's pre-programmed path. Another object of the invention is to have Logic circuits that will allow the users to have “N” number of destination choices to choose from depending upon how much memory/storage space is built into the automatic-transport system's circuitry.

Another object is to provide a wireless remote system that will allow you to control the automatic-transport system and to view system operations and to control the automatic-transport system through a remote control wand unit having controls and display functions that display its whereabouts on the grid through GPS means in the optional deluxe model of the wireless remote system.

On regular models using a remote system, remote features would include activation means for sending control and display means for activating the automatic-transport system to make a delivery and or to control its route and reporting functions, and or to program the unit and to enter security codes to unlock secure contents and or to otherwise operate the unit. In the consumer take-out-the-garbage mode, if programmed to do so, the remote system will transmit a signal to turn the automatic-transport system on, it will have the option to open the garage door via sending a transmission to open a garage door opener via it's own transmitter, it will then unlock itself, it will then proceed to deliver the garbage, it will then go to the drop-off point, it will then electromechanically drop off the garbage for none-empty cans, it will then return or stay optionally at the drop off site and lock down there, after the garbage is collected it will return to the garage and go back to its designated loading zone and lock down so it cannot be stolen.

Another object is to provide optional logic circuitry and functionality and the proper scanners in an array aboard the automatic-transport system to be able to read a central taped or glued line or painted line on the floor ground, pavement, asphalt highway, street, etc., and an intelligence built-in to discriminate from guiding left or right such lines to tell the automatic-transport system if it is going off-course with auto-correction means to automatically steer the system back unto the central line.

Another object is to provide other components in the automatic-transport system to include functionality of an optional paint-spraying mechanism on deluxe models where the automatic-transport system can be programmed to draw a painted line or to dispense and glue a length of tape on the floor of garages or driveways, or on factory floors, or other environments with components where the automatic transport system can later read the painted line(s) and or the taped line(s) through its barcode scanner(s) when it is in operation mode.

Another object is to provide an automatic-transport system with logic circuits and a special barcode scanner that reads the barcodes of the cargo or the people's identification tags that climb aboard the automatic-transport system whereby the automatic-transport system through its wireless communication port can transmit to a remote computer the time and date that the cargo or the person has boarded the automatic-transport system and report the automatic-transport system's coordinates through GPS coordinate mapping or through the scan information the automatic-transport system has in its memory from scan information it picks up from barcodes the automatic-transport system reads while traveling in a facility, on a floor, on pavement or wherever the barcodes are placed and can be read by the automatic-transport system's scanners (the scanners on the automatic transport system can be placed in front, behind, on the sides, or on the bottom of each unit and units can be combined together in train-like chain-like fashion multi-wagon fashion for volume movement operations.

Another object of the invention is to provide logic circuits into the automatic-transport system that will remain active once a delivery is made in the consumer or in the commercial version(s) whereby when the automatic-transport system leaves the loading zone and drops off garbage or items at the destination zone and or returns to the loading zone it remains in “Stand By” Mode for a programmable amount of time which is settable that will allow the user to re-fill the automatic-transport system with more garbage or cargo or pallets, mail, machined parts, construction, passengers, military, emergency, or other materials, and then allow the user to resend the transport system to the drop-off or to the same destination, or to another destination area.

Another object of the invention is to provide a logic circuit that will count the number of re-sends that the automatic-transport system is sent each time when the unit is sent out and to subtract a wagon-length of pallets or cargo or garbage to place the items in their appropriate locations through optional electromechanical transfer systems so that the automatic transport system can subtract the distance it has to travel on each journey on each successive send if it is to place the garbage in a row right after each other in a line, or to lay out cargo, pallets, materials, or garbage as programmed by GPS coordinates, taped or painted lines, or through other methods.

Another object is to provide an automatic-transport system with scanning and GPS functions that will allow an automatic-transport system to be constructed that will allow contents to be moved from one location to a designated area by a user pressing a button on the unit to send it in manual mode, or in automatic mode when the unit is filled to capacity a weight sensor will activate the unit to start the motors that will move the wheels of the unit to follow the line in the direction chosen (to designated area “X”, back to loading area “Y”, forward or reverse) as chosen in the programming of the automated-transport system to a designated area, for “Z” length away from the loading area.

Another object of my invention is to provide an electronic device with built-in GPS functionality that will automatically record GPS coordinates over time as it is moved plotting the location of where it traveled to allow the automatic programming of the automatic-transport system so a path can be automatically downloaded to the automatic transport system so the automatic transport system can then move to follow those coordinates and walk through a manufacturing plant, manufacturing cells, quality control cells, testing cells, painting cells, process cells, packaging cells, warehousing, offices, mail routing, mail rooms, through military establishments, for field operations, for military, battlefield, commercial, intelligence or other operations to allow the delivery of a person, people, or items or cargo on the platform(s) of the automatic-transport system just like the electronic device was walked through within a certain programmable settable deviation.

Another object of my invention is to provide programmability where the automatic-transport system can be programmed to recognize when it is in a “Loading Zone” and to travel a certain distance “Z” from a “Loading Zone” to go to a “Destination Zone”, then proceed to return to the “Loading Zone” or to proceed further to another “Zone” by following a line that is either painted on the floor, or taped on the floor.

Another object of my invention is to provide an automatic-transport system that has the ability to select a direction from a fork in the road where the tape it reads or the line it reads on the floor has a multiplicity of lines (depending on the cargo it is carrying).

Another object of my invention is to provide an automatic-transport system with the functionality for the secure transfer of items from the transport system to secure storage areas or bins, or to secure mail systems, for packages, documents, parts, supplies and or containers, tapes, diskettes, CD-ROMS, or other media within corporate mail departments stops, mail routes, or rooms, or to secure containers for mail or other delivery to residential or business or industrial communities, with secure reporting functions with every delivery. Optional interfacing includes the ability to scan each stop it makes to see if its security code matches the code internal to the transport system for content drop off for each specific piece coded and entered into the system for delivery. Reporting functions also include wireless communications to alert computers of delivery times and to alert what was delivered and by whom, and other data.

Another object is to provide a automatic-transport system with scanning and GPS functions that will allow the construction of an automatic-transport system to be constructed that will allow at least one platform cargo area of any size to accommodate cargo of “Y” depending on how large the automated transport system platform is made and how sturdy it is made to accommodate the weight of items that will be placed upon the platform area. On models where the platform will be utilized for the loading and unloading of pallets the automatic-transport system will have electromechanical and or hydraulic or pneumatic means to drop the pallets when commanded to do so when the automatic transport system reaches its designated unloading area. Alternatively, the automatic-transport system can go into hold mode when it reaches its designated destination and alert the manager, an employee, or other people that it has arrived through wireless communications to a computer via email, or it can just drop of contents and return back to the loading area automatically, or wait to be sent back by user interaction after entering a security code. On other systems where the automatic-transport system is used for moving waste, or garbage cans, scrap or recyclable materials, contaminated waste, radioactive materials, chemicals, bio-hazardous waste or other materials, boxes or canisters, or drums, or where items are valuable, special electromechanical holding arms can be utilized that will lock the items in the automatic-transport system while it is moving and it will release the items from the automatic-transport system only upon a security code being triggered. Prior to such entering of a security code no release of the items will be made. When the security code is entered a further functionality of the system allows wireless connection to interface with a company's software system to update warehousing records that items are received and now in stock in the warehouse, furthermore the items will be locked in place in the automatic-transport system until they get to their destination for added security while the automatic-transport system is moving. The security code can be entered automatically by the system once it has traveled to its destination after traveling “X” or “Y” distance, forward or reverse, of length “Z” as it was programmed to do so, or it will unlock its contents after a user, an employee or manager with authority enters a security code.

Another object is to provide a automatic-transport system with scanning and GPS functions that will allow the creation of different automatic-transport systems to be made that can scan and follow lines drawn or painted on pavement or asphalt or read tape glued on pavement or asphalt and travel from a start position to an end destination to deliver items or people from one location to another, and or by employing GPS, (global positioning system technology coordinates and trail navigation techniques where one can draw a path precisely how they would like to travel utilizing GPS coordinates mapping).

Another object of my invention is to provide an automatic-transport system for moving people or items from one location to another with the functionality to allow the automatic-transport system to make a choice at each destination or at each stop to select from a series of directions it can go to from each stop it makes through GPS coordinates stored in memory for the next location it will travel to or by following a certain painted or taped line on the floor through scanner means that it is programmed for. These coordinates or choices can be changed on the fly manually by an interface on the built-in automatic-transport system's control unit or through wireless means through a computer remotely. The automatic-transport system can be programmed to drop people off going through “X” number of nodes or destination(s) and it can be programmed to return to any destination or to proceed to another destination through line scanning means or through GPS coordinate traveling means.

Another object of my invention is to provide an automatic-transport system with platform support for moving people or objects from one location to another with optional support structure(s) to accommodate the securing of objects to be placed into or unto the platforms or further support structures for people to support themselves while traveling on the platforms such as something to hold onto when the platform is moving, such as a rail, or something to sit on, such as chairs, or benches, for extra comfort.

Another object of my invention is to provide an automatic-transport system with a wireless communication port that will allow an interface to computers and a software interface that will allow accounting records to be updated and emails to be sent out to managers and employees and others that will update records when cargo or people have arrived at a certain destination or node in a plant or warehouse or other area, and also to show where the automatic-transport system is at any place in time.

Another object of my invention is to provide an automatic-transport system with an array of sensors and logic circuits that will keep the automatic-transport system on top of the painted line or the taped line and to follow it while the automatic-transport system is moving to its destination(s) through automatic steering correction mechanisms.

Another object of my invention is to provide an automatic-transport system with the automatic lock-down capability to automatically lock itself down through male and female locking mechanisms mating either to a wall and or to a floor where the automatic-transport system can lock itself down once arriving at a destination for a delivery so it cannot be stolen, having the further automatic ability to unlock itself at a pre-programmed time and travel back to the loading zone or to another destination as programmed or as manually directed.

Another object of my invention is to provide an automatic-transport system with logic circuits and an array of scanners and or optional GPS circuitry that will allow the automatic-transport system to operate in either a forward or a reverse direction in following a path whether the automatic-transport system is following a taped or glued line on the floor through scanning means or whether it is following GPS coordinates. This functionality is especially useful on driveways in the consumer version of the garbage “send” version of the automatic transport system, or in other tight areas, where the automatic-transport system would operate in the forward position to take out the garbage from the garage after opening the door of the garage, take it out to the front of the driveway, drop off the garbage, and then return by reversing direction by operating in the reverse direction following the taped or glued line or optional GPS coordinates stored in memory back into the garage for the length that it needs to travel as it is stored in memory.

This forward and reversing feature is especially useful in all areas where a line is the best possible direction to follow where the automatic transport system might be prohibited from turning around (like in the event a car may be parked in the driveway and the automatic transport system needs to go past it and get back in without turning around, where simply reversing direction may be the best way to go back.)

Another object of my invention is to have logic circuits in the automatic-transport system that will enable it to go forward and or reverse on the fly as controlled by a wireless communication port to multiple locations via a remote computer, or as preprogrammed and stored in the memory of the automatic-transport system, or as such settings can be adjusted manually by the control panel on the automatic-transport system and or overridden by the user by a security code.

Another object of my invention is to provide an automatic-transport system with scanning ability to not only be able to scan lines taped or painted on pavement or asphalt or roads, but to be able to scan bar codes or other symbols that can relate information to the automatic-transport system so that the automatic-transport system will know where it is and display that information on a display panel as programmed, and or so that information may be transmitted through the wireless communication port to a remote computer to tell a computer where the automatic-transport system is that cargo, or people have arrived at a particular destination. In the GPS models, the automatic-transport system can always tell the display on the automatic transport system map where it is at any point in time, or GPS coordinates can be fed to a remote computer at all times to track where an automatic-transport system is at all times.

Another object of my invention is to provide an automated-transport system with a Locking System consisting of a locking pin on the automatic-transport system that mates with and locks with a pin that is cemented in the ground or in the floor of a factory or a garage or a particular destination where the automatic-transport system locks down at when programmed to or when completing a run after making a delivery and returning to a loading area or to another destination so the automatic-transport system cannot be stolen.

Another object of my invention is to provide an automatic-transport device that has to read a barcode or receive a GPS or other computer signal to lock itself down unto a locking pin so the automatic-transport system cannot be stolen after completing a journey. This feature will allow the automatic-transport system to read a barcode at its designated return area after completing a journey to lock itself down such as after delivering the garbage (in home units) or after completing a delivery from docks in warehousing operations and returning to the garage (home units) and locking itself down so it cannot be moved and or stolen. Upon activation again, the automatic-transport system will unlock itself. The garbage version can also be made to lock-down and be kept at home anywhere desired. It can be made to lock down and be kept and activated to deliver garbage to a destination zone from inside a garage by opening a garage door through its built-in garage door opener, or it can be made to unlock itself from lock down from any posted area serving as a loading zone (where the unit can be outside of a garage; i.e. such as sitting outside the back door of a house), and then proceed to a destination, drop-off zone upon activation to drop-off the garbage.

Another object of my invention is to provide logic circuits for an automatic-transport system that will allow a platform cargo area to be moved from one location to another by following a painted line, a taped line, or GPS coordinates fed to it. Special logic will be built-into the automatic-transport system where if the system is manually taken off the painted or the taped lines that may be on the pavement or the floor, a user can then move the transport system on its wheels to the nearest barcode on the floor or posted area where the user can park the automatic-transport system back on-top of the taped line or the painted line on the floor or the pavement and enter in the barcode at that location that will tell the automatic-transport system how far the unit is from the next designated area by scanning in the location of the automatic-transport system to reprogram its location where the user can then activate commands to send it on its way to the next desired location back on its path.

Another object of my invention is to provide logic circuits for an automatic-transport system that will allow a platform cargo area to be moved from one location to another by following a painted line, a taped line, or GPS coordinates fed to it with special logic that will enable the automatic transport system to alert employees, managers, or consumers if the automatic-transport system is normally functioning and or is on its path by making an audible beeping sound or other sounds and or alerts including specific and different voice messages and alerts while it is coming through or otherwise announcing its presence while passing to warn employees and or if: 1) the automatic-transport system malfunctions, 2) if something is blocking the automatic-transport system's path and the unit cannot proceed in its path, 3) if the automatic-transport system goes off-course, 4) and if it deviates from the GPS coordinates, (or from the taped line or painted line(s) on the designated course), via, email, paging means, phone messaging, visual and or audible beeps or alerts, or other alerts via wireless communication, or other communication means and or by audible or visual means at the automatic-transport system or remotely through the automatic-transport system's wireless communication port.

Another object of the invention is to provide logic circuits and sensors and the intelligence to control the automatic-transport system to stop and request directions or to return to its loading zone when an alert cripples it from reaching its destination point either from an obstruction, a malfunction, from something blocking its path, from something not causing the cargo to being delivered to the programmed destination within a certain amount of time, if the system goes off-course, if it deviates from GPS coordinates, etc.

Another object is to provide a automatic-transport system with scanning and GPS functions that will allow an automatic-transport device to be developed for home use for the consumer that will either sit on the side of their garage, or in their garage, or somewhere outside a person's home that as in many suburban settings an automatic-transport system can be utilized to automatically deliver garbage, yard waste and recyclable items to the front of a person's driveway, or from their back door or from their garage to their alley, so that waste haulers can take the garbage away automatically.

Another object of my invention is to provide an automatic-transport device that will have a series of platforms in a consumer version that will allow consumers to place at least one garbage can on each platform unit, each platform unit having a weight sensor to determine if the garbage can is empty. The consumer programs the date and time he or she wants the unit to put the garbage out. The automatic-transport system has an internal clock that keeps track of the time and date.

Another object of my invention is to provide an automatic-transport system that also has a radio transmitter that will trigger the garage door opener and open it automatically, with a time delay to wait until the garage door opens completely before the automatic transport system travels out to the front of the driveway so the automatic-transport system can travel outside of the garage unattended following the line or the tape glued to the pavement or the asphalt driveway.

Another object of my invention is to provide a logic circuit that will allow the automatic-transport device to return back inside the garage where it might be kept for safe keeping and close the garage door by transmitting a remote wireless signal to the garage door opener via remote means after the automatic-transport system returns to its loading area back inside the garage (where the automatic-transport system might be kept in home use for loading) after dropping-off the garbage in front of the driveway or to the alley or to a designated spot for the waste haulers. Also, the automatic-transport system can sense which of the platforms in the chain of platforms in the automatic-transport system are empty. When the automatic-transport system reaches its destination, if the garbage can is empty it is not ejected, but rather it is taken back to the garage, or to the original loading area.

It is proposed that consumers use the first can first, the second can second, the third can third, and so on when filling them in order for proper operation that the automatic-transport system may drop off garbage cans one next to another when reaching its destination so that it would make things easier for waste haulers, and so things will look neater at the end of the driveway (this is illustrated in the drawings).

Another object of my invention is to provide an automatic-transport system in various models where one automatic-transport system can have multiple platforms built into it with weight sensors of “X” size, and “Y” shape, and also in alternative versions where a chain of platforms can be connected together so that a consumer or a commercial user can add or subtract as many platforms as he or she may require per run depending on how many garbage cans or pallets or platforms he or she wants to move at a time.

In the models where a chain of platforms are used the automatic-transport system will have the intelligence to sense how many platforms are connected together, and it will release only the items above a certain weight if programmed to do so, or all the items, as desired upon reaching its destination as previously mentioned, and the release mechanisms will work on every platform as programmed, no matter how many or how few platforms are connected together. The automatic-transport system will work to release all items chained together, every item above a certain weight, or every item brought to the destination on every platform.

Another object of my invention is to provide mechanisms in the automatic-transport system that will allow the automatic-transport system to move items securely and to drop off items at designated areas at their proper designated drop-off place with reporting functions to report success or failure of the process through wireless communication means to a remote computer, to a cell phone or to pagers, to faxes, to programmable digital assistants, or utilizing other communication systems.

Another object of my invention is to provide an automatic-transport system that can be used to move objects in manufacturing lines from one operation cell to another. The wheels of the automatic-transport system can be modified to be installed on a track, or to be installed in a geared track, or the automatic-transport system can travel from one location to another on the manufacturing floor with rubber tires, or with rubber tracks, or other traction means.

Another object of my invention is to provide an automatic-transport device for consumer use to deliver recyclable disposal bins, garbage cans, disposal containers, plastic bags, paper leaf bags, etc. from a loading area to a designated area such as the end of a driveway, to the alley, or to a designated spot for pick-up by waste haulers triggered for movement after a consumer manually triggers the automatic-transport system to deliver the garbage for waste removal to the programmed area, and return the automatic-transport system back to its loading area, where the automatic-transport system has the option to either send a remote transmission to open the garage door, or where the consumer can set the automatic-transport system to be in total manual mode where the consumer sets the system to make sure he opens the garage door and then he manually triggers the automatic-transport system to send the garbage out. In manual mode the automatic-transport system always returns to the designated loading area after dropping off the “recyclable disposal bins, garbage cans, disposal containers, plastic bags, paper leaf bags, etc.” at the programmed drop-off site or distance from the loading area.

Another object of the present invention is to provide logic, circuitry, memory circuits within the automatic transport system, within the remote control unit and or within the programmable digital assistant including interface means to allow one to program the automatic-transport system to perform operational functions described within the scope of the present invention such as loading and unloading items into and out of the automatic transport system, and or docking and locking down on a pin cemented on the ground or docking elsewhere, to send an email to designated parties through a wireless port that it has arrived at a particular destination when it arrives at each location, to unlock a secure cargo upon receiving a code, how to perform operation(s), in what order to perform them and what to do after it performs them such as to dock there, to lock down and shut down, or to proceed to another location or to go to a series of location(s) and perform additional task(s) or to return to the sending location.

Another object of my invention is to provide software for the automatic-transport system to operate the unit remotely and on board the unit through its wireless port and through the command console to program it to travel to certain destinations, to arrange schedules, and to activate it to send it to different destinations following either GPS coordinates programmed in its memory or to follow line paths that can be scanned by its scanners in forward or reverse for “N” length journeys and destinations; and to lock-down at each destination as programmed upon reaching the destination, and to electromechanically drop-off contents to be delivered in either a secure fashion or to hold items for release by a security code by an authorized individual.

Another object of my invention is to provide an automatic transport system whereby it can use operational memory that would record speed and steering signals and other operating parameters to drive the automatic transport system via macro(s) to go from one destination to another and to perform operation(s) as desired to deliver and or go to pick up items and return to a location or proceed to another location.

Another object of my invention is to provide means to load and unload contents into and out of the automatic-transport system through one or more mechanisms designed to load or unload content(s) into and or out of the automatic-transport system comprised of electromechanical, pneumatic, and or hydraulic transfer systems with and or without grasping mechanisms to take hold of and or grab onto garbage cans, boxes or other items that are to be loaded or unloaded into or out of the automatic-transport system; and or an automatic-transport system further comprised of ejecting arms that will push off slidable pallet(s), drums, bins, bags, boxes or other objects off of the automatic-transport system onto the ground or floor; and or an automatic-transport system further comprised of optional dockable and releasable platform areas that can be locked into place or unlocked and used to place items upon them that can be released, ejected and docked into or out of the automatic-transport system and that can be used to place contents upon them where said platform areas can also be wheeled-pallet(s), that can be placed into or out of the automatic-transport system that can lock in place and dock with the automatic-transport system and released at a designated drop off point whereby once it is dropped off said wheeled pallets are further comprised of lockable wheel systems so as to lock in place to prevent further movement once dropped-off the platform areas from within the automatic-transport system unto a designated delivery point upon disengagement from the automatic-transport system.

Another object of this invention is to provide an automatic-transport system that will upon receiving an authorized signal allow the loading or release of lockable-and-unlockable-dockable-wheeled-platform areas into or out of the automatic-transport system from any side of the automatic transport system including in front of the automatic-transport system, behind the automatic-transport system, or on the left or the right of the automatic-transport system through electromechanical, pneumatic and or hydraulic means at a designated drop-off or loading point authorized and verified by GPS coordinates.

Another object of this invention is to provide an automatic-transport system that will create an authorized signal to drive circuits that will eject and or load items out of or into platform areas of the automatic-transport system from any side of the automatic transport system including in front of the system, behind the system, on the left or the right of the system through electromechanical, pneumatic and or hydraulic means at a designated drop-off or loading point authorized and verified by GPS coordinates.

Another object of the present invention is to provide an automatic-transport system in an array of various different models some comprising a model with a steering mechanism in the front of the automatic-transport system and another steering mechanism in the back of the unit so that the automatic-transport system can be steered to follow either a forward or a reverse path in either direction and go forward by switching to the desired steering system or to follow a reverse path on the fly without having to turn around for the convenience to follow a taped or painted line in reverse or to reverse the automatic-transport system's path in a GPS path without having to turn around by just switching from the forward steering system to the opposite reverse steering system and reversing its path direction whereby if it was scanning lines to a destination, it would use its reverse looking scanner sensors to scan for a taped or painted line on the floor or the ground and use the reverse steering system, or whereby if it was using GPS coordinates it would reverse the path in its computer memory and follow the path directions backwards from its location back to its destination; further if it was using operational memory that would drive the automatic transport system's operation via macro(s) then the automatic-transport system would travel forward in reverse using its reverse steering system on its path and follow macro instruction(s) as well and the system would also have the ability to switch back and forth between forward and reverse steering system(s) as it is commanded to do so by the signals it receives.

Another object of the present invention is to provide means to selectively control when and how electromechanical, pneumatic, and or hydraulic electromechanical transfer systems operate to load or unload, secure and hold items, release items, and or to load or to eject items off of platform areas, and or to allow the docking or undocking of lockable and unlockable platform wagon(s) and wheeled pallet(s) and to allow the mechanisms and the automatic-transport system to operate under a variety of modes including automatically as programmed, remotely and or manually under operator intervention upon enterring a security identification code.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

Other objects and advantages of the present invention will become apparent from the following descriptions, taken in connection with the accompanying drawings, wherein, by way of illustration and example, an embodiment of the present invention is disclosed.

### SUMMARY OF THE INVENTION

In view of the foregoing disadvantages inherent in the known types of automatic-transport system now present in the prior art, the present invention provides a new automatic-transport system with scanning and GPS functions construction wherein the same can be utilized for moving people or objects, including but not limited to pallets of items, boxes, cargo, drums, garbage cans, bins, manufactured parts from one cell to another, documents, mail, construction materials, chemicals, waste, hazardous materials, military supplies, radioactive materials, supplies, etc. on platforms or items placed on an automatic-transport system that can be ejected from it and delivered from one location to another and to return automatically or to proceed to other destination(s) by following GPS coordinates, and or by following a line painted or taped to a floor through scanners built into the automatic-transport system.

The general purpose of the present invention, which will be described subsequently in greater detail, is to provide a new automatic-transport system with scanning and GPS functions that has many of the advantages of the automatic-transport system mentioned heretofore and many novel features that result in a new automatic-transport system with scanning and GPS functions which is not anticipated, rendered obvious, suggested, or even implied by any of the prior art automatic-transport system, either alone or in any combination thereof.

To attain this, the present invention generally comprises electromechanical motors or means employing a variety of engine means (including combustion means if desired) as desired for the development of an automated transport system to move contents from one physical location to another.

Other components of my invention include logic circuits that will enable the automatic-transport system to arrive at a destination and alert a manager or employee or both or other people electronically, or a consumer in consumer models to take further action, or to automatically trigger the cell it comes to unload the automated transport system utilizing electromechanical transfer system(s), and or to drop off contents automatically and return where the automatic transport system came from, or to await instructions from an employee to be sent back to where it came from.

Other components of the automatic-transport system include a wagon-like automated-transport system having at least three (3) or (4) four wheels per platform area or automated transport system. Where (1) or two (2) wheels of the automated-transport system will be used for steering the automated-transport system attached to an electromechanical steering system controlled by a circuit designed to follow a line, no matter how it is drawn, in direction “X or Y”, forward or reverse, for length “Z” through scanners installed on the bottom and or the front/back, bottom, and or side(s) of the unit, and or by employing GPS coordinates and directions without the need for employing the use of lines and scanners, and where the other two wheels will be used for stability and to make it mobile. Furthermore, further components include mechanisms that will allow an automated-transport system to lock its wheels as it is moving so as not to slide down a slope as it is moving things if the transport system is going up or down a gradient.

Other components on various models of the automatic-transport system include an optional suspension system for every wheel of the automatic-transport system or for every track of the automatic-transport system (if treads are used in the design), for going over uneven terrain when the automatic-transport system if following GPS coordinates on its path, or for when the automatic-transport system is following a taped line or a painted line on pavement or on flooring or asphalt or on the ground, or even if the automatic transport system has to climb or go up and down steps, over steps, through ditches, or over bumps over a variety of speeds.

Other components of the automatic-transport system include an optional paint-spraying mechanism on deluxe models where the automatic-transport system can be programmed to draw a painted line or to dispense and glue a length of tape on the floor of garages or driveways, or on factory floors, or other environments with components where the automatic transport system can read the painted line(s) and or the taped line(s) through its barcode scanner(s) when it is in operation mode.

Other components of the automatic-transport system include logic circuits that will allow people or contents to be moved from one location to a designated area by a user pressing a button on the unit to send it in manual mode, or in automatic mode when the unit is filled to capacity a weight sensor will activate the unit to start the electromechanical or combustion motors that will move the wheels of the unit to follow the taped line on the pavement or the painted line in the direction chosen (to designated area “X”, back to loading area “Y”, forward or reverse) as chosen in the programming of the automated-transport system to a designated area, for “Z” length away from the loading area, or by using GPS coordinates to go to a location.

Other components of my invention is to provide an electronic device with logic circuits having built-in GPS functionality that will automatically record GPS coordinates over time as it is moved plotting the location of where it traveled to allow the automatic programming of the automatic-transport system so a path can be automatically downloaded to the automatic-transport system so the automatic-transport system can then move to follow those coordinates and walk through a manufacturing plant, manufacturing cells, quality control cells, testing cells, painting cells, process cells, packaging cells, warehousing, offices, mail routing, mail rooms, through military establishments, for field operations, for military, battlefield, commercial, intelligence or other operations to allow the delivery of a person, people, or items or cargo on the platform(s) of the automatic-transport system just like the electronic device was walked through within a certain programmable settable deviation.

Other components of my invention include logic circuits to provide programmability where the automatic-transport system can be programmed to recognize when it is in a “Loading Zone” and to travel a certain distance “Z” from a “Loading Zone” to go to a “Destination Zone”, then proceed to return to the “Loading Zone” or to proceed further to another “Zone” by following a line that is either painted on the floor or taped on the floor.

Other components of my invention is to provide logic circuits in the automatic-transport system that has the ability to select a direction from a fork in the road as selected and programmed in memory where the tape it reads or the line it reads on the floor has a multiplicity of lines (depending on the cargo it is carrying).

Other components of my invention include the construction of an automatic-transport system to be constructed that will allow at least one platform cargo area to be moved from one location to another. Said platform area can be constructed in a fashion to allow the receipt of items to be placed upon the automatic-transport system or for one or more people to step and stand on the platform to be moved from one location to another depending on how large the automated transport system platform is made and how sturdy it is made to accommodate the weight of items that will be placed upon the platform area. On models where the platform will be utilized for the loading and unloading of pallets the automatic-transport system will have electromechanical and or hydraulic or pneumatic means to drop the pallets when commanded to do so when the automatic transport system reaches its designated unloading area.

Alternatively, the automatic-transport system can go into hold mode when it reaches its designated destination and alert the manager, an employee, or other people that it has arrived through wireless communications to a computer via email, or it can just drop off contents and return back to the loading area automatically, or wait to be sent back by user interaction after entering a security code or to proceed to another destination or area.

On other systems where the automatic-transport system is used for moving waste, or garbage cans, scrap or recyclable materials, contaminated waste, radioactive materials, chemicals, bio-hazardous waste or other materials, boxes or canisters, or drums, or where items are valuable, special electromechanical holding arms can be utilized that will lock the items in the automatic-transport system while it is moving and it will release the items from the automatic-transport system only upon a security code being triggered. Prior to such entering of a security code no release of the items will be made. When the security code is entered a further functionality of the system allows wireless connection to interface with a company's software system to update warehousing records that items are received and now in stock in the warehouse, furthermore the items will be locked in place in the automatic-transport system until they get to their destination for added security while the automatic-transport system is moving. The security code can be entered automatically by the system once it has traveled to its destination after traveling “X” or “Y” distance, forward or reverse, of length “Z” as it was programmed to do so, or it will unlock its contents after a user, an employee or manager with authority enters a security code.

Other components of my invention will allow the creation of different automatic-transport systems to be made that can scan and follow lines drawn or painted on pavement or asphalt or read tape glued on pavement or asphalt and travel from a start position to an end destination to deliver items or people from one location to another, and or by employing GPS, (global positioning system technology coordinates and trail navigation techniques where one can draw a path precisely how they would like to travel utilizing GPS coordinates mapping).

Other components of my invention include an automatic-transport system with an array of sensors and logic circuits that will keep the automatic-transport system on top of the painted line or the taped line and to follow it while the automatic-transport system is moving to its destination(s), and as a failsafe a multiplicity of lines can be used a certain number to the left of the center line and a certain number to the right of the center line so that scanners can read the lines and always center themselves in towards the middle line so as not to go off-course while the automatic-transport system is moving towards its destination(s).

Other components of my invention include logic circuits with the functionality to allow the automatic-transport system to make a choice at each destination or at each stop to select from a series of directions it can go to from each stop it makes through GPS coordinates stored in memory for the next location it will travel to or by following a certain painted or taped line on the floor through scanner means that it is programmed for. These coordinates or choices can be changed on the fly manually by an interface on the built-in automatic-transport system's control unit or through wireless means through a computer remotely. The automatic-transport system can be programmed to drop people off going through “X” number of nodes or destination(s) and it can be programmed to return to any destination or to proceed to another destination through line scanning means or through GPS coordinate traveling means.

Other components of my invention include an automatic-transport system with platform support for moving people or objects from one location to another with optional support structure(s) to accommodate the securing of objects to be placed into or unto the platforms or further support structures for people to support themselves while traveling on the platforms such as something to hold onto when the platform is moving, or something to sit on for extra comfort.

Other components of my invention include an automatic-transport system with a wireless communication port that will allow an interface to computers and a software interface that will allow accounting records to be updated and emails to be sent out to managers and employees and others that will update records when cargo or people have arrived at a certain destination or node in a plant or warehouse or other area as they occur.

Other components of my invention include an automatic-transport device that will have a series of platforms in a consumer version that will allow consumers to place at least one garbage can on each platform unit, each platform unit having a weight sensor to determine if the garbage can is empty.

Other components include logic circuits that allow the consumer to program the date and time he or she wants the unit to put the garbage out. The automatic-transport system has an internal clock that keeps track of the time and date. Furthermore, the automatic-transport system also has logic circuits that enable it to use a radio transmitter that will trigger the garage door opener and open it automatically, with a time delay to wait until the garage door opens completely before the automatic transport system travels out to the front of the driveway or to the alley so the automatic-transport system can travel outside of the garage or to the designated drop-off area unattended following the line or the tape glued to the pavement or the asphalt driveway.

Other components of my invention is to provide a logic circuit that will allow the automatic-transport device to return back inside the garage where it might be kept for safe keeping and close the garage door by transmitting a remote wireless signal to the garage door opener via remote means after the automatic-transport system returns to its loading area back inside the garage (where the automatic-transport system might be kept in home use for loading) after dropping-off the garbage in front of the driveway or at its designated drop-off area in the alley for the waste haulers.

Other components of my invention include logic circuits in the automatic-transport system with the use of weight sensors that can sense which of the platforms in the chain of platforms in the automatic-transport system are empty. When the automatic-transport system reaches its destination, if the garbage can is empty it is not ejected, but rather it is taken back to the garage, or to the original loading area. It is proposed that consumers use and fill the first can first, the second can second, the third can third, and so on when filling them in order for proper operation that the automatic-transport system may drop off garbage cans one next to another when reaching its destination so that it would make things easier for waste haulers, and so things will look neater at the end of the driveway or in the alley (this is illustrated in the drawings).

Other components of my invention is to provide an automatic-transport system in various models where one automatic-transport system can have multiple platforms built into it with weight sensors of “X” size, and “Y” shape, and also in alternative versions where a chain of platforms can be connected together so that a consumer or a commercial user can add or subtract as many platforms as he or she may require per run depending on how many garbage cans or pallets or platforms he or she wants to move at a time. In the models where a chain of platforms are used the automatic-transport system will have the intelligence to sense how many platforms are connected together, and it will release only the items above a certain weight if programmed to do so, or all the items, as desired upon reaching its destination as previously mentioned, and the release mechanisms will work on every platform as programmed, no matter how many or how few platforms are connected together. The automatic-transport system will work to release all items chained together, every item above a certain weight, or every item brought to the destination on every platform. Another object of my invention is to provide an automatic-transport system that can be used to move objects in manufacturing lines from one operation cell to another.

The wheels of the automatic-transport system can be modified to be installed on a track, or to be installed in a geared track, or the automatic-transport system can travel from one location to another on the manufacturing floor with rubber tires, or with rubber tracks, or other traction means.

Other components of my invention include logic circuits and functionality and controls in an automatic-transport device for consumer use to deliver recyclable disposal bins, garbage cans, disposal containers, plastic bags, paper leaf bags, etc. from a loading area to a designated area such as the end of a driveway or to an alley for pick-up by waste haulers triggered for movement after a consumer manually triggers the automatic-transport system to deliver the garbage for waste removal to the programmed area, and return the automatic-transport system back to its loading area, where the automatic-transport system has the option to either send a remote transmission to open the garage door, or where the,consumer can set the automatic-transport system to be in total manual mode where the consumer sets the system to make sure he opens the garage door and then he manually triggers the automatic-transport system to send the garbage out. In manual mode the automatic-transport system always returns to the designated loading area after dropping off the “recyclable disposal bins, garbage cans, disposal containers, plastic bags, paper leaf bags, etc.” at the programmed drop-off site or distance from the loading area.

Other components of my invention include circuit card(s) containing logic circuits for all of the functions mentioned in the objects or advantages of my invention.

Other components of my invention include wireless communication means to interface with computers for updating accounting records when cargo or people have arrived at a certain destination.

Other components of my invention include a battery strong enough to drive the electronic motors that will drive the motors and the electronics of the automatic-transport system for the weight load(s) the automatic-transport system will be carrying, or combustion engines powerful enough to move the loads they will be carrying.

Other components of my invention include an automatic-transport system with scanning ability to not only be able to scan lines taped or painted on pavement or asphalt or roads, but to be able to scan bar codes or other symbols that can relate information to the automatic-transport system so that the automatic-transport system will know where it is and display that information on a display panel as programmed, and or so that information may be transmitted through the wireless communication port to a remote computer to tell a computer where the automatic-transport system is that cargo, or people have arrived at a particular destination. In the GPS models, the automatic-transport system can always tell the display on the automatic transport system map where it is at any point in time, or GPS coordinates can be fed to a remote computer at all times to track where an automatic-transport system is at all times.

The Automatic-Transport System Has A Number Of Main Components And Subcomponents Including But Not Limited To: Electromechanical Motors, Other Motors, Or Combustion Motors Used To Move People Or Objects Placed On The Platforms Of The Automatic-Transport System; Scanners Used To Read Lines Drawn On Pavement So That The Automatic-Transport System Can Follow A Painted Line Or A Taped Line Course To Destination(s), And To Read Bar Codes To Report Where The Automatic-Transport System Is At Any Point In Time; A Global Positioning Coordinate System Device That Will Enable A User To Download Path Data To The Automatic-Transport System So That The Automatic Transport System Can Travel To Programmed Destination(s); A Steering Control System That Will Be Used To Turn The Automatic-Transport System To Follow GPS Coordinates As Downloaded Or To Follow Taped Or Painted Lines On The Pavement Or Factory Or Warehouse Or Office Floors Through Scanning Means; The Circuit Card(s) Employed By The Automatic-Transport System Contain All The Logic Circuits That Have The Functionalities Contained In The Objects Or Advantages Of The Present Invention; The Wireless Communication Port Is An Interface That Allows The Automatic-Transport System To Communicate With Remote Computers To Update Accounting Records, To Send Emails To Employees, Managers, And Other People As To The Arrival Of People, Cargo, Or Items To A Designated Area Through Built-In Logic And Or Software, And To Control Where The Automatic-Transport System Goes For Unattended Automatic Operation Via Computer Control; The Built-In User Interface Allows A User To Manually Control The Automatic-Transport System Having Data-Entry Means And Or Control Means And Display Means To Control System Go To A Certain Location By Entering A Security Code As Pre-Programmed Or To Change It On The Fly;

Electromechanical, Pneumatic, Or Hydraulic Release Mechanisms Are Used To Hold And Lock Down Cargo Or Items While They Are In Transport For Security Reasons And They Release Items Upon A Security Code Being Entered Either Automatically When Reaching A Destination Or Upon A User Entering A Security Code; Optional Support Structures Can Be Built-into The Automatic-Transport System To Accommodate Cargo So Cargo Or Items Can Be Supported Better Or Handled More Efficiently Or To Make Their Handling More Secure; In The Case Of Moving People, Support Structures Can Include A Holding Bar Where A Person Or People Can Hold On To A Rail When The Platform Is Moving, Or Other Support Structures Such As Seating Can Be Provided; And The Locking System Consists Of A Locking Pin On The Automatic-Transport System That Mates With And Locks With A Pin That Is Cemented In The Ground Or In The Floor Of A Factory Or A Garage Or A Particular Destination Where The Automatic-Transport System Locks Down At When Programmed To Or When Completing A Run After Making A Delivery And Returning To A Loading Area So The Automatic-Transport System Cannot Be Stolen.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

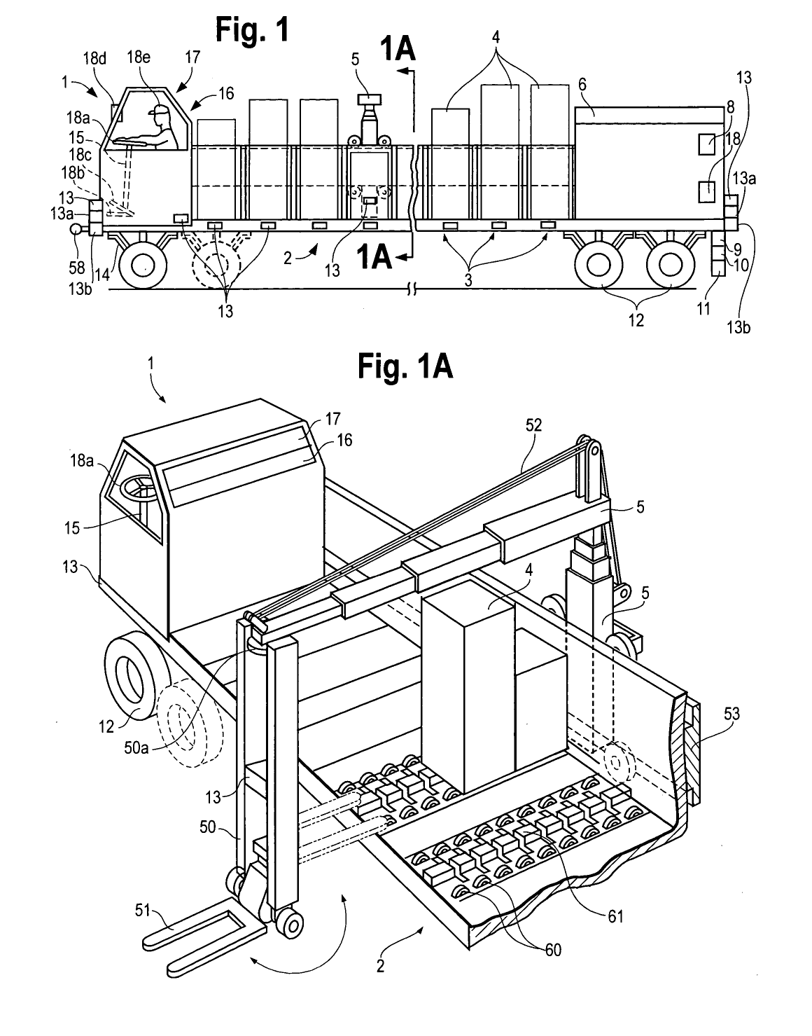

FIG. 1 is a schematic view of the cargo entry side of the automatic transport system vehicle having optional electromechanical, pneumatic, hydraulic and or robotic transfer system mechanism(s) depicting a “cargo” handling automatic transport system with multiple platform bays for multiple cargo handling functionality that can load and unload said cargo.

FIG. 1A is a partial rear perspective view of FIG. 1 depicting a “cargo” handling automatic transport system with multiple platform bays for multiple cargo handling functionality and electromechanical transfer means that can load and unload said cargo.

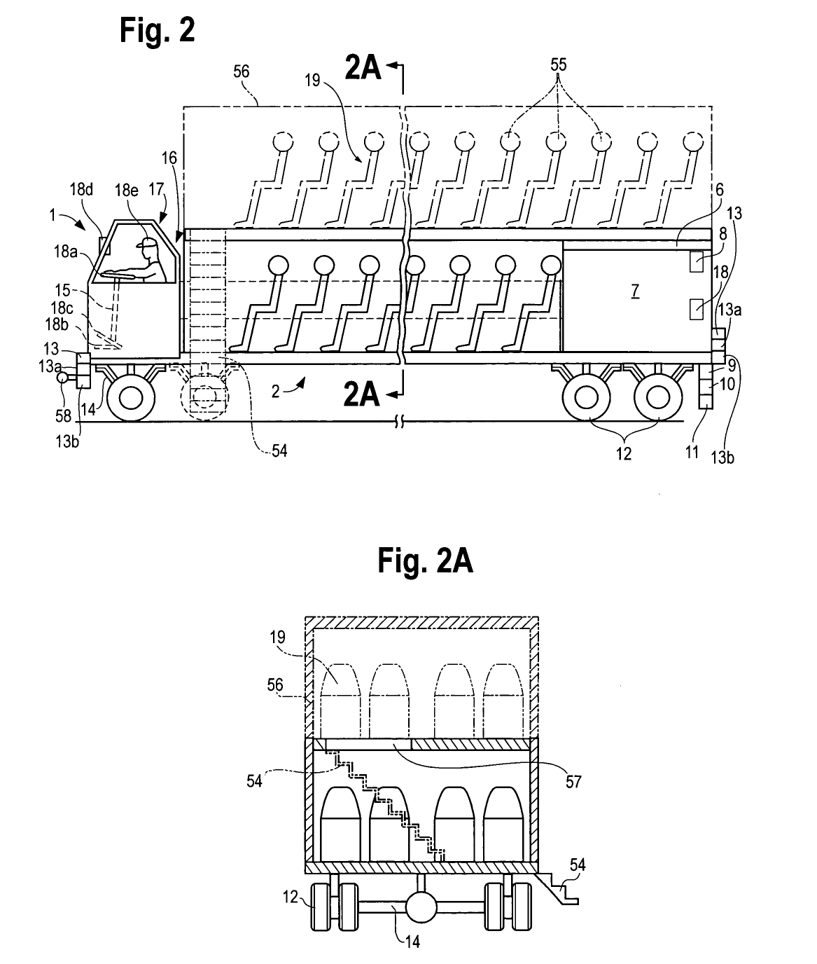

FIG. 2 is an operator's side elevation schematic view of the present invention depicting a “people-moving” automatic transport system with multiple platforms for multiple people moving capabilities.

FIG. 2A is a verticle cross-section 2A-2A taken from FIG. 2 of the present invention depicting a “people-moving” automatic transport system with multiple platforms for multiple people moving capabilities.

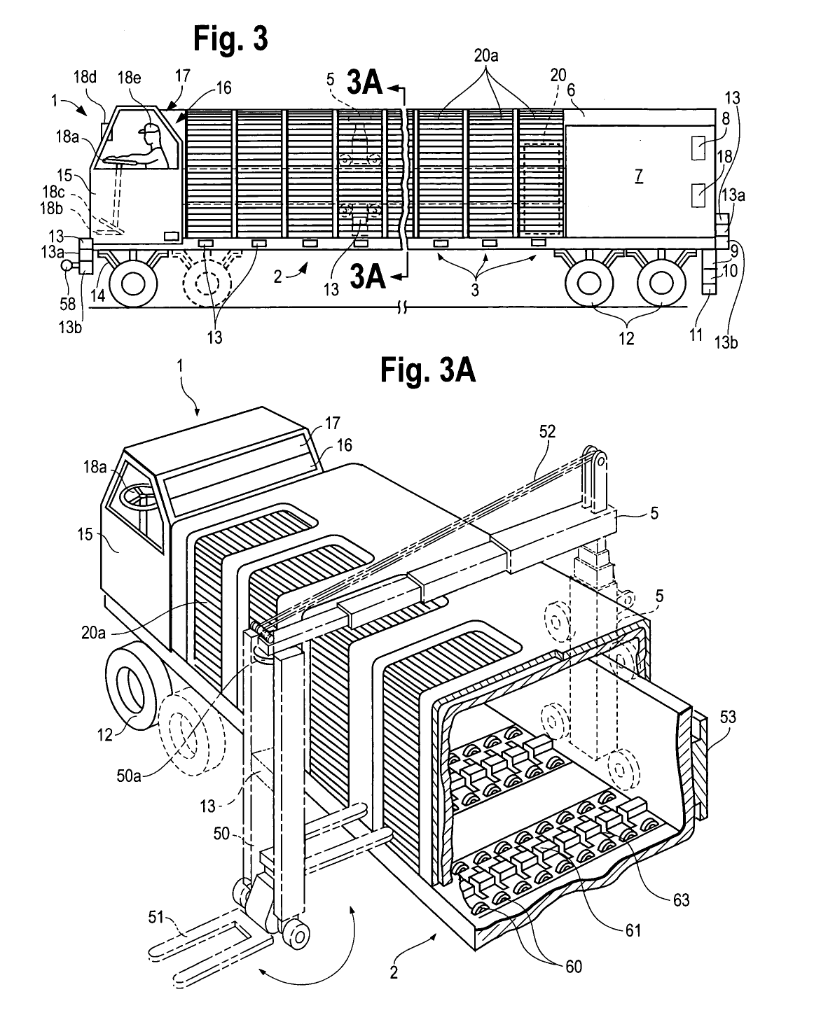

FIG. 3 is an operator's side elevation schematic view of the cargo entry side of the automatic transport system vehicle with automatic and or manual, lockable closure means and having multiple platforms for multiple pallets and or cargo with electromechanical transfer means that can load and unload said pallets and or cargo and locking closure means for secure transport of contents.

FIG. 3A is a partial rear perspective of FIG. 3 of the present invention depicting a “pallet and or a cargo” handling automatic-transport system with multiple platforms for multiple pallets and or cargo with electromechanical transfer means that can load and unload said pallets and or cargo and locking closure means for secure transport of contents.

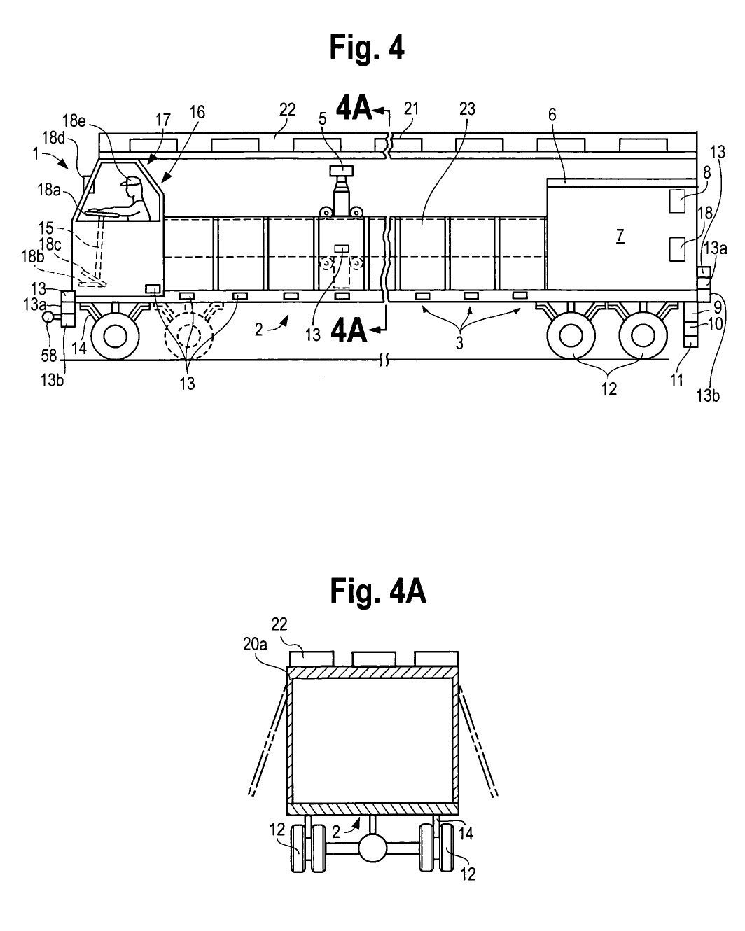

FIG. 4 is an operator's side elevation schematic view of the cargo entry side of the automatic transport system vehicle having optional transfer system(s) for use in manufacturing cell to cell application(s) with multiple platforms and table top access for multiple positional access and exchange of parts for manufacturing operations that transport system and parts may be moved from one manufacturing cell to another with electromechanical, pneumatic, and or hydraulic robotic transfer means that can load and unload manufactured parts from multiple platform areas and from the automatic-transport system's table top access.

FIG. 4A is a verticle cross-section 4A-4A taken from FIG. 4 depicting a manufacturing cell to cell automatic transport system with multiple platforms and table top access for multiple positional access and exchange of parts for manufacturing operations from one manufacturing cell to another with electromechanical, pneumatic, and or hydraulic robotic transfer means that can load and unload manufactured parts from multiple platform areas and from the automatic-transport system's table top access.

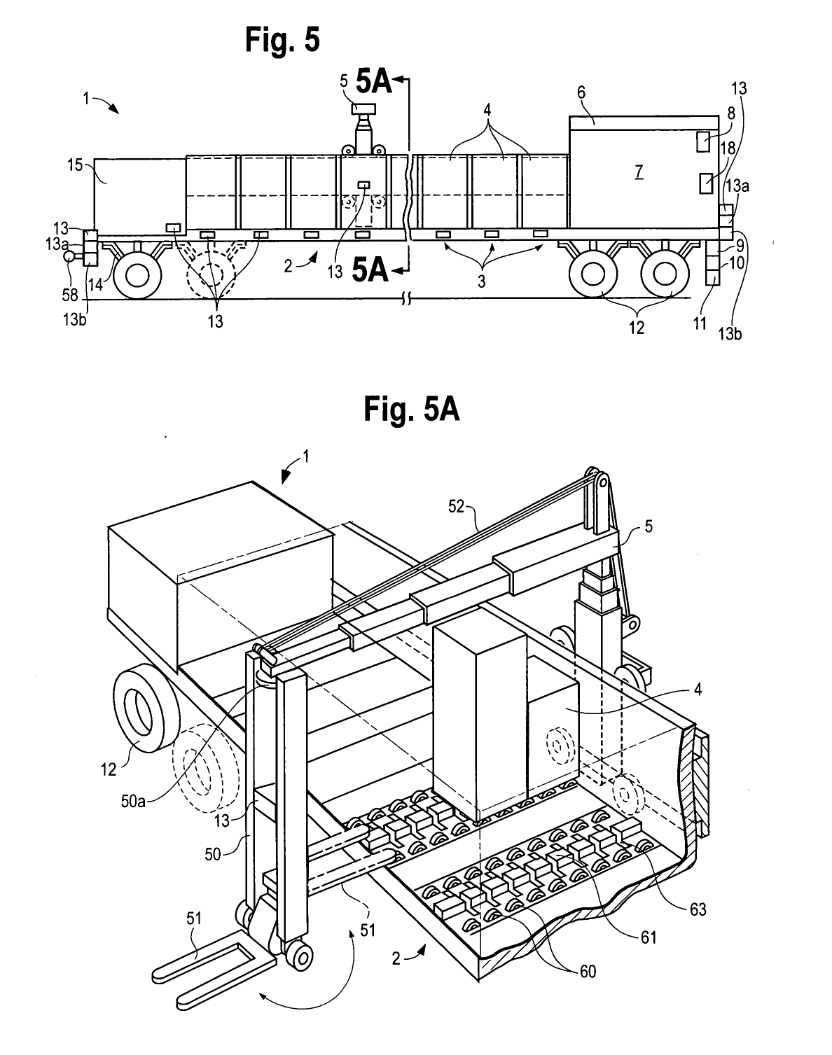

FIG. 5 is a non-motorized operator's side elevation schematic view of the cargo entry side view of the automatic transport system vehicle having optional transfer system(s) which has a dockable payload with multiple platforms that can be locked down and dropped off at designated locations or dragged and or used to attach to a motorized automatic-transport unit to extend payloads.

FIG. 5A is a partial rear perspective view of FIG. 5 of the non-motorized dockable payload automatic transport system with multiple platforms that can be locked down and dropped off at designated locations or dragged and or used to attach to a motorized automatic-transport unit to extend payloads.

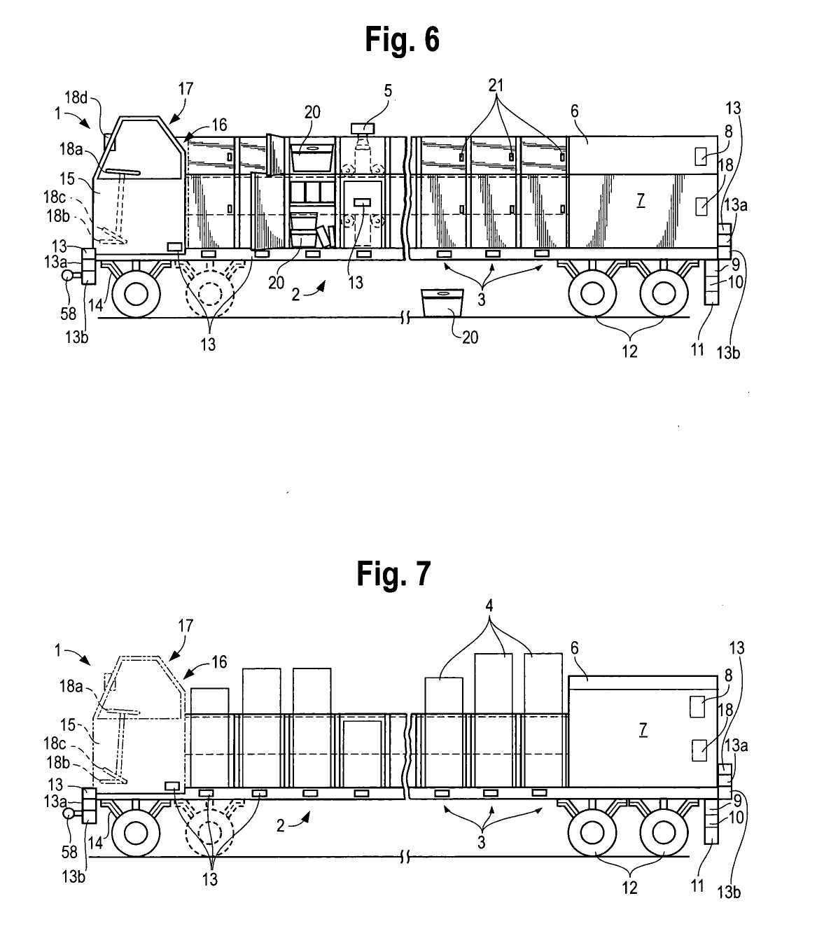

FIG. 6 is a schematic view of the cargo entry side of the automatic transport system vehicle having optional electromechanical, pneumatic, hydraulic and or robotic transfer system mechanism(s) for delivering secure mail or supplies with multiple platforms to handle mail or supplies that can load and unload said mail or supplies.

FIG. 7 is an optional operator's schematic view of the cargo entry side of the automatic transport system vehicle having optional electromechanical, pneumatic, hydraulic and or robotic transfer system mechanism(s)a side plan view of the present invention depicting an automatic transport system with multiple platforms to handle cargo having an optional driver seat and steering system and optional accelerator and braking system whereby models can be developed that have their own automatic steering, acceleration, and braking system(s).

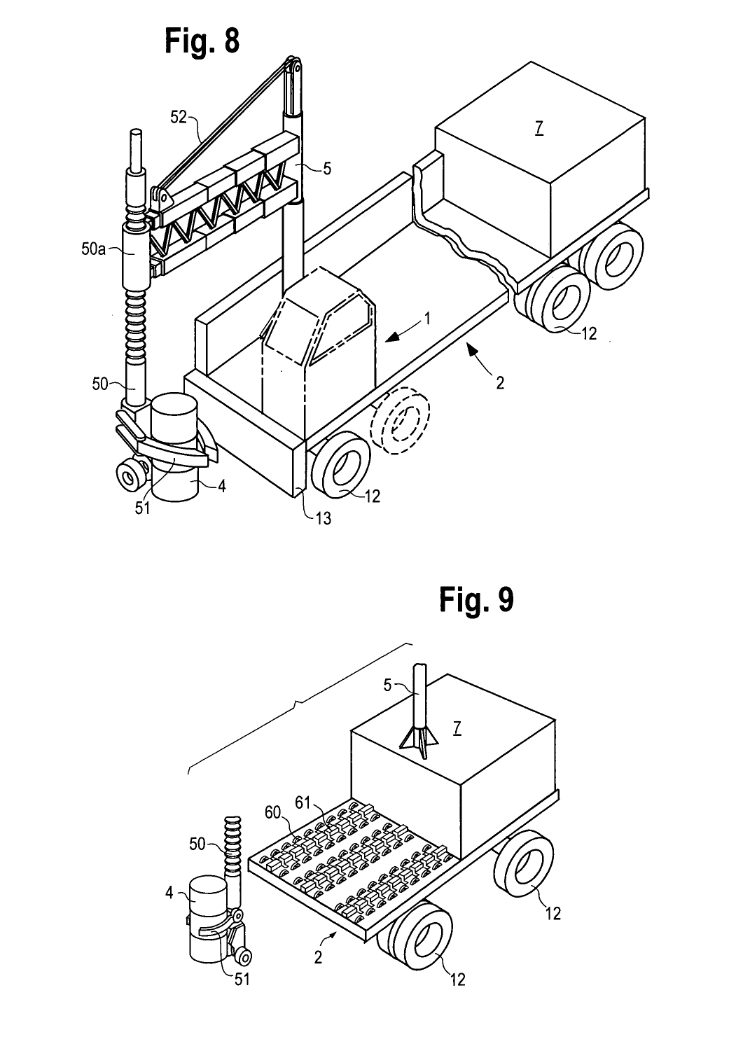

FIG. 8 is a front perspective view of optional operator front load/unload automatic transport vehicle system with multiple platform bay area(s) to handle and load or unload cargo having an optional driver seat and steering system and optional accelerator and braking system whereby models can be developed that have their own automatic steering, acceleration, and braking system(s), also having electromechanical, pneumatic, and or hydraulic robotic transfer mechanisms for loading and or unloading cargo.

FIG. 9 is a front perspective view of a compact front load/unload warehouse cargo management vehicle having front load platform bay area(s) depicting an automatic transport system with at least one platform bay area mounted in front of the automatic transport system to load or unload cargo having an automatic steering system, accelerator and braking system also having electromechanical, pneumatic, and or hydraulic robotic transfer mechanisms for loading and or unloading cargo.

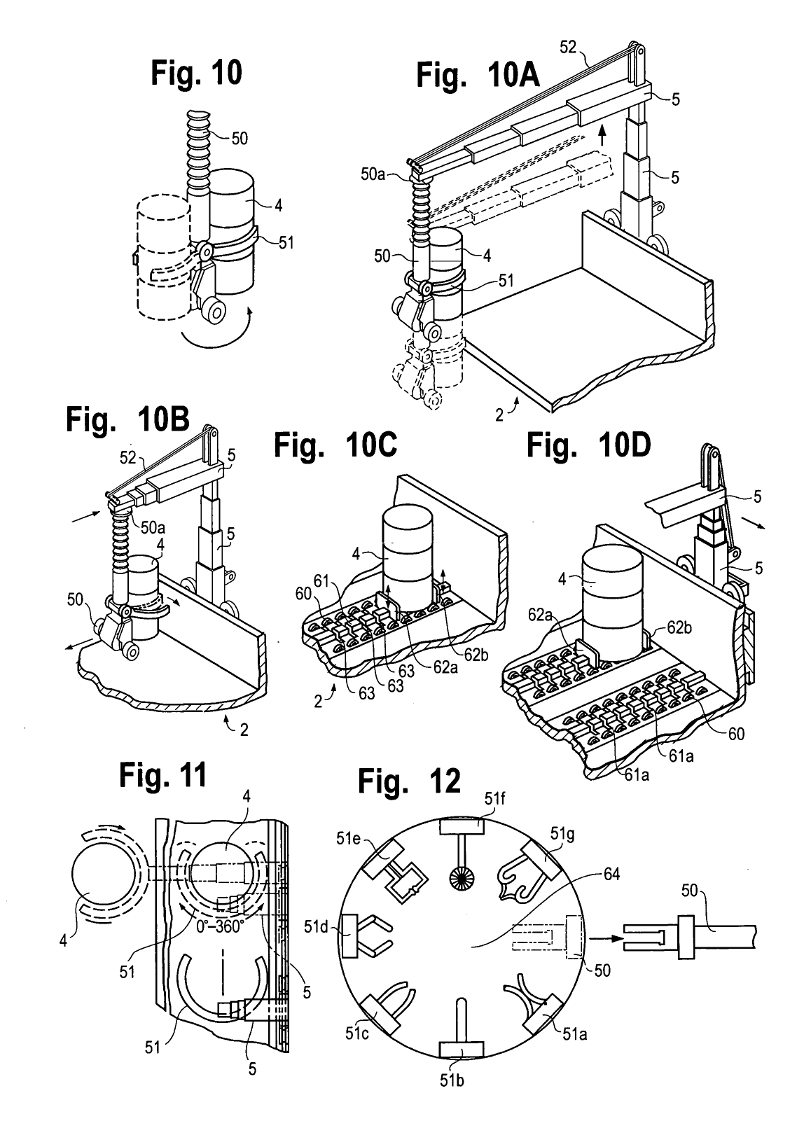

FIG. 10 is a schematic view of the present invention depicting a electromechanical, pneumatic, hydraulic and or robotic grasping mechanism designed to load or unload specific types of cargo items.

FIG. 10A is a schematic view of the present invention depicting a electromechanical, pneumatic, hydraulic and or robotic grasping mechanism picking up a cargo item and either loading it or unloading it from the automatic transport system.

FIG. 10B is a schematic view of the present invention depicting a electromechanical, pneumatic, hydraulic and or robotic grasping mechanism either placing the cargo item unto the transport system, or getting ready to pick up the cargo item to unload it.

FIG. 10C is a perspective view of the present invention depicting a cargo item after it has been placed unto the transport system, where primary and secondary barriers can either be raised to secure it in place for transport, or where primary and secondary barriers can be lowered for unloading.

FIG. 10D is a perspective view of the present invention depicting a cargo item after it has been placed unto the transport system, and primary and secondary barriers have been raised to secure it in place for transport in models where there are transfer mechanism(s) that have been moved to the next platform bay position after placing the cargo unto the transport system to park the transfer system in an empty designated platform bay or to disengage from the cargo.

FIG. 11 is a top plan view of the cargo tranfer system showing a robotic transfer mechanism grasping and loading or unloading cargo unto or off of the transport system bed showing electromechanical, pneumatic, hydraulic and or robotic grasping mechanisms designed to grab cargo and directionally turn and rotate cargo 0-360 degrees as desired and determined by programmable logic to load and unload cargo into and out of the transport system.

FIG. 12 is a top plan view of a carousel exchange system for use with different robotic transfer mechanism(s) having “n” number of various electromechanical, pneumatic, hydraulic and or robotic-type grasping arm(s) or manipulator(s) designed to load or unload different types of cargo in and out of the automatic transport system models.

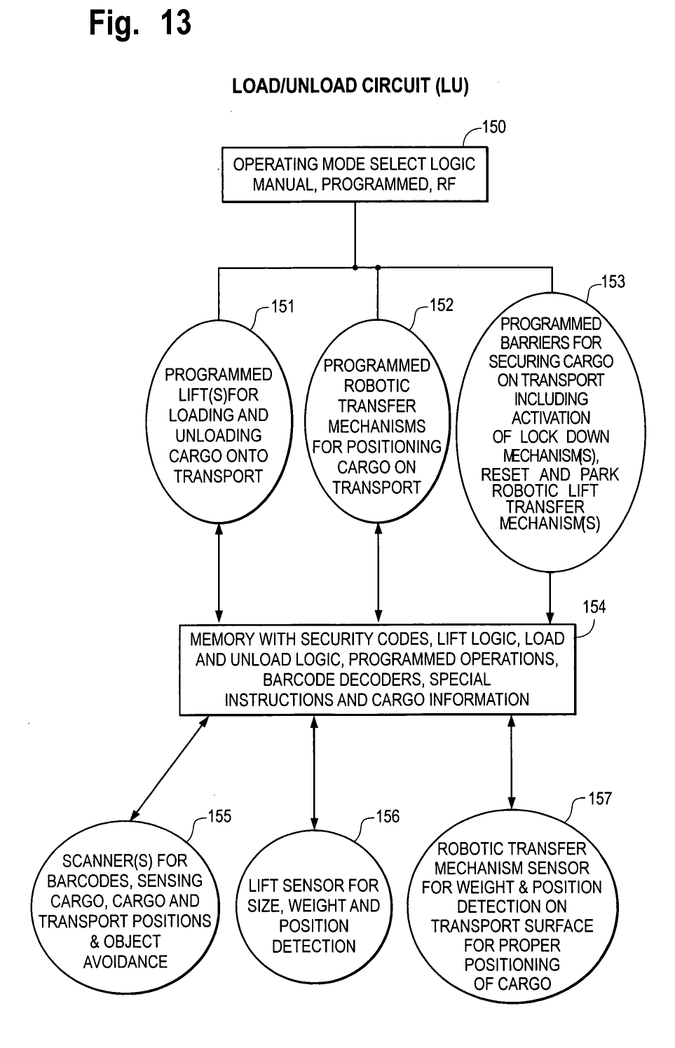

FIG. 13 is a logic block diagram of the Load/Unload Circuit (LU).

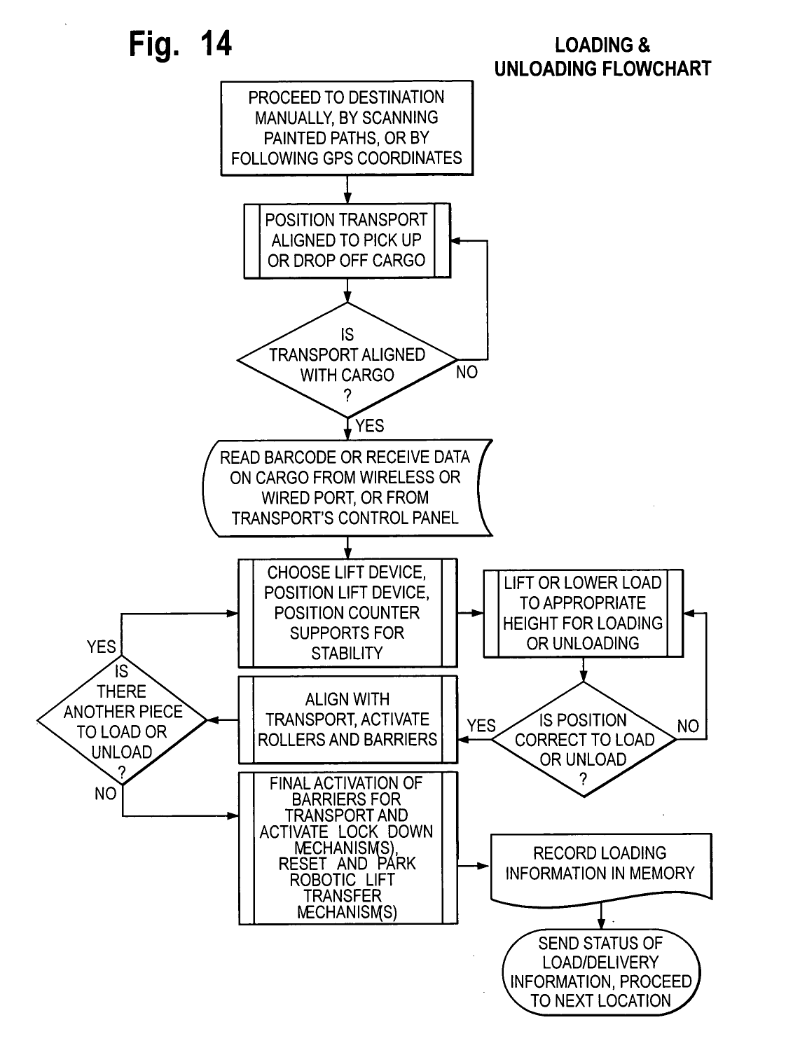

FIG. 14 is a Loading And Unloading Flowchart.

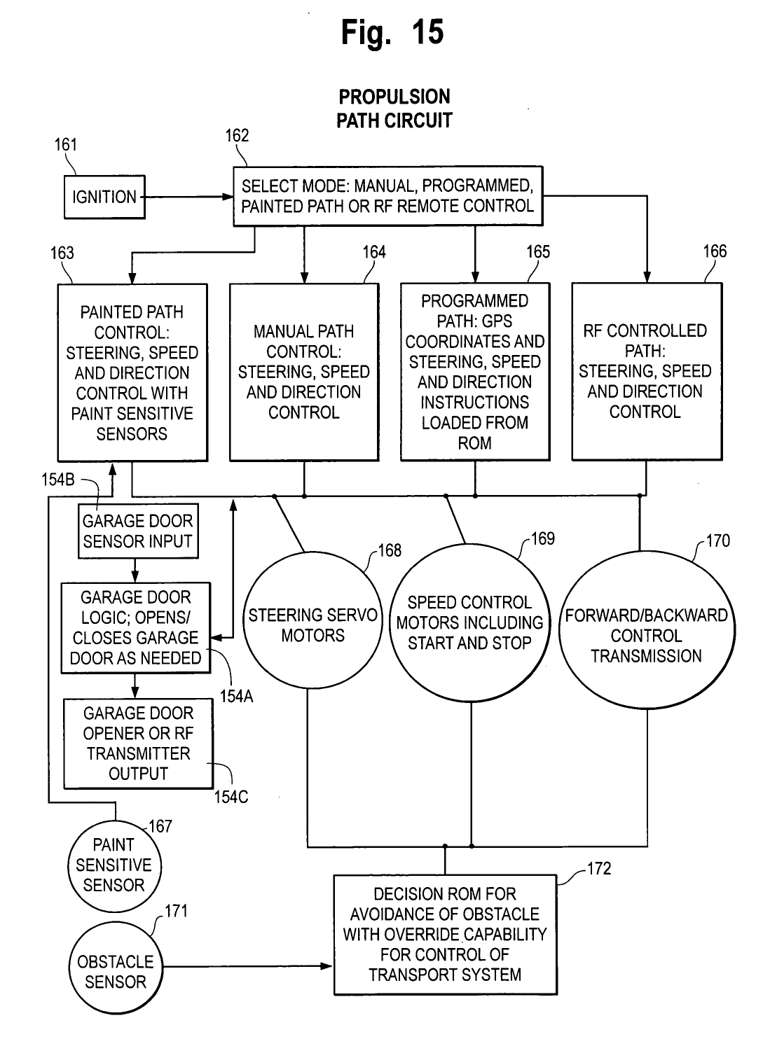

FIG. 15 is a logic block diagram of the Propulsion Path Circuit.

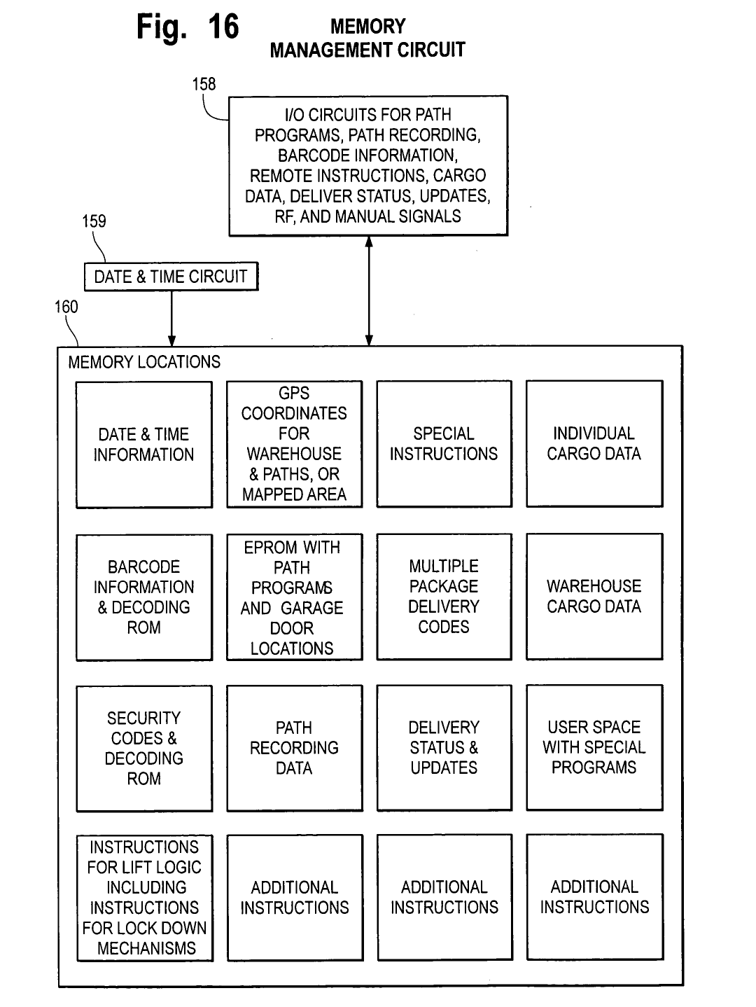

FIG. 16 is a logic block diagram of the Memory Management Circuit.

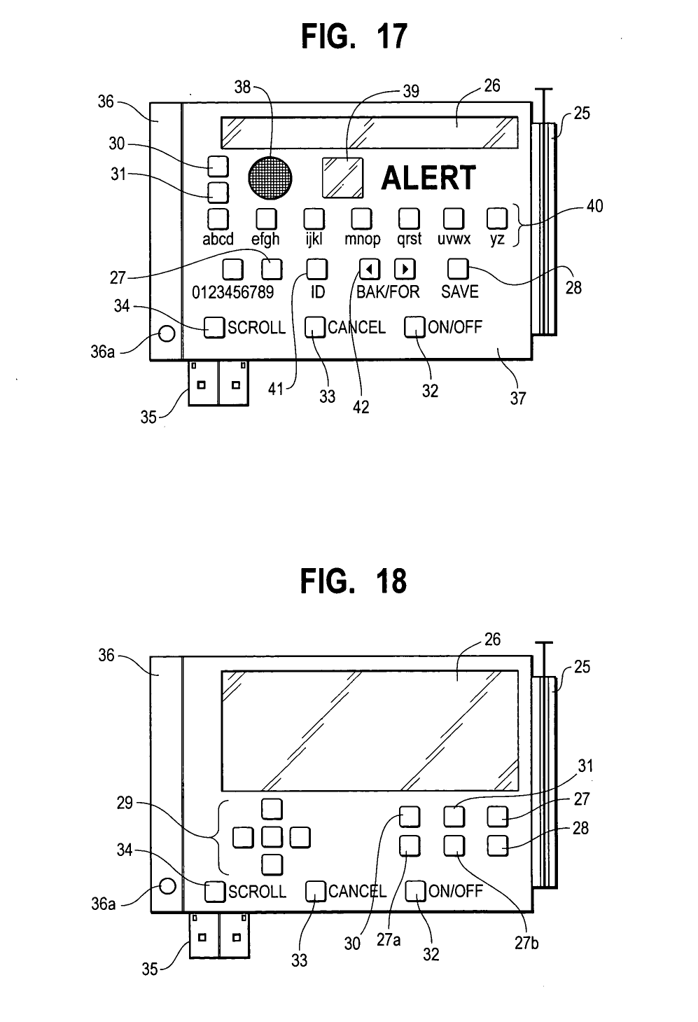

FIG. 17 is a plan view of the present invention depicting a programmable digital assistant (PDA) and or a wireless remote designed to record GPS coordinates over time and save them for downloading to the automatic-transport system either through a wired connection or through wireless means.

FIG. 18 is a plan view of the present invention depicting a programmable digital assistant (PDA) and or a wireless remote designed to record GPS coordinates over time and save them for downloading to the automatic-transport system either through a wired connection or through wireless means.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### DETAILED DESCRIPTION OF THE INVENTION

Turning now descriptively to the drawings, in which similar reference characters denote similar elements throughout the several views, the attached figures illustrate an automatic-transport system and or machine with forward-looking and reverse-looking scanning means and having GPS receiving means that is may go on path(s) that are downloaded to it either through wireless or through wired means through a port and GPS reporting capabilites and functions to report its position as it is travelling, having GPS receiving and transmitting circuits 18, and or RF modulation receiving and transmitting circuits 18 with an antenna, and a remote control unit utilized to control the path and the operations of the automatic-transport system, said automatic-transport system further comprised of electromechanical motors or means employing a variety of engine means (including combustion means if desired) as desired for the development of an automated transport system to move contents from one physical location to another. Other components of my invention include logic circuits, knobs, buttons, dials, and or other manual interface means that will enable a user to control the automatic-transport system through a panel on the automatic-transport system, through a remote control unit, and or a programmable digital assitant, or through a computer, to arrive at a destination and alert a manager or employee or both or other people electronically, or a consumer in consumer models to take further action, or to automatically trigger the cell it comes to unload the automated transport system utilizing electromechanical transfer system(s), and or to drop off contents automatically and return where the automatic transport system came from, or to await instructions from an employee to be sent back to where it came from.

FIG. 1 is a side plan view of the present invention depicting a “cargo” handling automatic-transport system 1 with “n” number of platforms 2 each having weight sensor(s) 3, said platforms designed for the placement of one or more pieces of cargo such as pallets, drums, garbage cans, bins, and or bags, etc. 4 of different sizes and electromechanical transfer means 5 for grabbing the cargo or garbage cans, bins, and or bags to load or unload them from said automatic-transport system. Said transport system is further comprised of a circuit control system 6 that contains circuits to capture the radio frequency of a garage door opener to use it to open the door, an internal clock and the logic to control the system, circuitry to set the day(s) of the week and the times when to make deliveries or to overide the same through wireless or wired means 8 and RF modulation circuits 18, other operational circuitry; an electronic motor with a battery 7 or a combustion driven engine 7, a wireless communication port 8 which can also be used to open an electronic garage door opener through RF modulation circuits 18, a paint spraying system that can paint a line on the ground 9 that the automatic-transport system can follow, a waterproof tape-laying system 10 that the automatic transport system can lay on the floor or ground so that the transport system can later follow, a docking-locking system 11 that is designed to lock to a pin cemented to the ground upon arriving to a destination; forward-and-reverse-looking scanners 13 for reading taped or painted lines and or barcodes in designated areas for following a path and for resetting area coordinates to give the automatic-transport system location information; forward and or reverse obstacle avoidance sensor(s) or scanner(s) 13a; cargo scanners 13b; a suspension system 14 with wheels 12 designed to go over uneven terrain, ditches, bumps, steps, etc.; a steering control system 15 which can be fully automated in some models without a driver with fully automated braking and acceleration to follow GPS coordinates or to follow a taped or painted line through scanning means 13; a LCD or other Information Display Unit 16; a manual control panel 17; GPS circuits, with transmission and receiving antennae and RF receiving and transmitting modulation circuits 18; an optional steering wheel 18a; an optional steering column 15; an optional manual brake 18b that can be used by a driver; an optional manual accelerator that can be used to select the speed of the motor of the transport system by the driver; a USB port or other computer port 18d; an ignition circuit 18e connected with wireless receiving circuits and operable with or without a key to start or shut down the unit. It should be understood that in fully automated transport system models there is no need of manual acceleration, or manual braking, or manual steering because the automated transport system has automated steering mechanisms, automated acceleration and automated braking and shutdown including fully automated pick up and unloading capabilities.

FIG. 1A depicts a “cargo” handling automatic-transport system 1 with “n” number of platforms 2 each having “n” number of roller wheels 60 and a slotted track 61 that allows primary and secondary barriers to rise up from the floor to secure cargo contents also having a track system rail 53 to allow the telescoping portion of the electromechanical, pneumatic, and or hydraulic robotic transfer mechanism 5 to move about the length of the transport system to move from platform bay to platform bay and whereas the electromechanical, pneumatic, hydraulic, robotic transfer mechanisms 50 and 51 then turn on the gear 50a to pivot and load or unload cargo 4 unto or off of the transport system. Further shown is a steering wheel 18a; and a steering column 15; and steerable wheel(s) 12 one drawn in phantom to show double wheels for heavier loads used in front and in back on both sides of the transport system; a LCD or other Information Display Unit 16; a manual control panel 17; forward-and-reverse-looking scanners 13 for reading taped or painted lines and or barcodes in designated areas for following a path and for resetting area coordinates to give the automatic-transport system location information, and in the case of the robotic transfer mechanism the scanner 13 either on the robotic transfer mechanism or elsewhere on the transport unit will scan to position the transfer mechanism and to analyze the type of cargo the cargo is to determine what kind of robotic transfer mechanism to use; forward and or reverse obstacle avoidance sensor(s) or scanner(s) 13a; and cargo scanners 13b.

FIG. 2 depicts a “people-moving” version of the automatic-transport system 1 with “n” number of platforms 2, said platforms designed for the placement of one or multiple seats, chairs, or benches 19 of different sizes. Said transport system is further comprised of a circuit control system 6 that contains circuits to capture the radio frequency of a garage door opener to use it to open the door, an internal clock and the logic to control the system, circuitry to set the day(s) of the week and the times when to make deliveries or to overide the same through wireless or wired means 8 and RF modulation circuits 18, other operational circuitry; and an electronic or a combustion driven motor 7, a wireless communication port 8, a paint spraying system that can paint a line on the ground 9 that the automatic-transport system can follow, a waterproof tape-laying system 10 that the automatic transport system can lay on the floor or ground so that the transport system can later follow, a docking-locking system 11 that is designed to lock to a pin cemented to the ground upon arriving to a destination; forward-and-reverse-looking scanners 13 for reading taped or painted lines and or barcodes in designated areas for following a path and for resetting area coordinates to give the automatic-transport system location information; forward and or reverse obstacle avoidance sensor(s) or scanner(s) 13a; cargo scanners 13b; a suspension system 14 with wheels 12 designed to go over uneven terrain, ditches, bumps, steps, etc.; a steering control system 15; a LCD or other Information Display Unit 16; a manual control panel 17; GPS circuits, with transmission and receiving antennae and RF receiving and transmitting modulation circuits 18; and a steering wheel 18a to overide automatic steering; an accelerator 18b to overide automatic speed controls; and a brake 18c to provide added control; a USB port or other computer port 18d; an ignition circuit 18e connected with wireless receiving circuits and operable with or without a key to start or shut down the unit. Further shown are seating arrangement(s) 19; people 55; an optional second floor 56 (drawn in phantom); and an optional staircase to the second floor 54 (drawn in phantom).

FIG. 2A depicts a second floor 56 (drawn in phantom) with a seating arrangement 19 an opening 57 proceeding to the first floor through a staircase 54 a retractable staircase 54 going outside to step off the transport unit; wheels 12 and a suspension system 14.

FIG. 3 depicts a “pallet or cargo moving” version of the automatic-transport system 1 with “n” number of platforms 2, said platforms designed for the placement of one or more pallet(s) or pieces of cargo, boxes, etc., of different sizes each having weight sensor(s) 3, and electromechanical transfer means 5 for grabbing the pallet(s) and or cargo to load or unload them from said automatic-transport system. Said transport system is further comprised of a circuit control system 6 that contains circuits to capture the radio frequency of a garage door opener to use it to open the door, an internal clock and the logic to control the system, circuitry to set the day(s) of the week and the times when to make deliveries or to overide the same through wireless or wired means 8 and RF modulation circuits 18, other operational circuitry; and an electronic or a combustion driven motor 7, a wireless communication port 8, a paint spraying system that can paint a line on the ground 9 that the automatic-transport system can follow, a waterproof tape-laying system 10 that the automatic transport system can lay on the floor or ground so that the transport system can later follow, a docking-locking system 11 that is designed to lock to a pin cemented to the ground upon arriving to a destination; wheels 12; forward-and-reverse-looking scanners 13 and weight sensors in platform bays 13 for reading taped or painted lines and or barcodes in designated areas for following a path and for resetting area coordinates to give the automatic-transport system location information; forward and or reverse obstacle avoidance sensor(s) or scanner(s) 13a; cargo scanners 13b; a suspension system 14; with wheels 12 designed to go over uneven terrain, ditches, bumps, steps, etc.; a steering control system 15; a LCD or other Information Display Unit 16; a manual control panel 17; GPS circuits, with transmission and receiving antennae and RF receiving and transmitting modulation circuits 18; a USB port or other computer port 18d; an ignition circuit 18e connected with wireless receiving circuits and operable with or without a key to start or shut down the unit a hitch 58; lock down closure means or lockable cover(s) 20a to secure cargo 20 a steering wheel 18a to overide automatic steering; an accelerator 18b to overide automatic speed controls; and a brake 18c to provide added control.

FIG. 3A depicts a “pallet or cargo moving” version of the automatic-transport system 1 with “n” number of platforms 2, said platforms designed for the placement of one or more pallet(s) or pieces of cargo, boxes, etc., of different sizes each having weight sensor(s) 3, and electromechanical transfer means 5 for grabbing the pallet(s) and or cargo to load or unload them from said automatic-transport system. Said transport system having “n” number of platform bays each having “n” number of roller wheels 60 and a slotted track 61 that allows primary and secondary barriers to rise up from the floor through slotted tracks 63 to secure cargo contents also having a track system rail 53 to allow the telescoping portion of the electromechanical, pneumatic, and or hydraulic robotic transfer mechanism 5 to move about the length of the transport system to move from platform bay to platform bay whereas the electromechanical, pneumatic, hydraulic, robotic transfer mechanisms 50 and 51 then turn on the gear 50a to pivot and load or unload cargo 4 unto or off of the transport system. It should also be noted that the transfer mechanism(s) 50 and 51 (shown in phantom) can be exchanged to accommodate different types of cargo items. Said transport system model is further comprised of a circuit control system 6 that contains circuits to capture the radio frequency of a garage door opener or an electromechanical door if the transport system is stored in a secure area to use it to open the door, an internal clock and the logic to control the system, circuitry to set the day(s) of the week and the times when to make deliveries or to overide the same through wireless or wired means 8 and RF modulation circuits 18, other operational circuitry; and an electronic or a combustion driven motor 7, a wireless communication port 8, a paint spraying system that can paint a line on the ground 9 that the automatic-transport system can follow, a waterproof tape-laying system 10 that the automatic transport system can lay on the floor or ground so that the transport system can later follow, a docking-locking system 11 that is designed to lock to a pin cemented to the ground upon arriving to a destination; wheels 12; forward-and-reverse-looking scanners 13 and weight sensors in platform bays 13 for reading taped or painted lines and or barcodes in designated areas for following a path and for resetting area coordinates to give the automatic-transport system location information; forward and or reverse obstacle avoidance sensor(s) or scanner(s) 13a; cargo scanners 13b; a suspension system 14; with wheels 12 designed to go over uneven terrain, ditches, bumps, steps, etc.; a steering control system 15; a LCD or other Information Display Unit 16; a manual control panel 17; GPS circuits, with transmission and receiving antennae and RF receiving and transmitting modulation circuits 18; a USB port or other computer port 18d; an ignition circuit 18e connected with wireless receiving circuits and operable with or without a key to start or shut down the unit a hitch 58; lock down closure means or lockable cover(s) 20a to secure cargo 20 a steering wheel 18a to overide automatic steering; an accelerator 18b to overide automatic speed controls; and a brake 18c to provide added control. It should be noted that the automatic transport system can be designed in two configurations one with a cab 15 and one without a cab 15 where a driver can be optional where a system can operate in a fully automatic mode where there is no need of manual acceleration, or manual braking, or manual steering because the automated transport system has automated steering mechanisms, automated acceleration and automated braking and shutdown including fully automated pick up and unloading capabilities.

FIG. 4 depicts a “manufacturing-cell-to-cell-part transfer” version of the automatic-transport system 1 with “n” number of platforms 2, held in an optionally available secure lockable holding area 22 that allows parts to be releasable by a code being entered, or parts can be held and transported on top of the transport unit 21 for easy access by manufacturing robots said platforms designed for the placement of manufactured items 23 of different sizes held below in a secure lockable holding area 22 that allows parts to be releasable by a code being entered, or parts can be held and transported on top of the transport unit 21 for easy access by manufacturing robots both areas equipped with optional electromechanical transfer means 5 for grabbing the manufactured items to load or unload them from said automatic-transport system. Said transport system is further comprised of a circuit control system 6 that contains circuits to capture the radio frequency of a garage door opener to use it to open the door, an internal clock and the logic to control the system, circuitry to set the day(s) of the week and the times when to make deliveries or to overide the same through wireless or wired means 8 and RF modulation circuits 18, other operational circuitry; and an electronic or a combustion driven motor 7, a wireless communication port 8, a paint spraying system that can paint a line on the ground 9 that the automatic-transport system can follow, a waterproof tape-laying system 10 that the automatic transport system can lay on the floor or ground so that the transport system can later follow, a docking-locking system 11 that is designed to lock to a pin cemented to the ground upon arriving to a destination; forward-and-reverse-looking scanners 13 for reading taped or painted lines and or barcodes in designated areas for following a path and for resetting area coordinates to give the automatic-transport system location information; forward and or reverse obstacle avoidance sensor(s) or scanner(s) 13a; cargo scanners 13b; a suspension system 14; with wheels 12 designed to go over uneven terrain, ditches, bumps, steps, etc.; a steering control system 15; a LCD or other Information Display Unit 16; a manual control panel 17; GPS circuits, with transmission and receiving antennae and RF receiving and transmitting modulation circuits 18; a USB port or other computer port 18d; an ignition circuit 18e connected with wireless receiving circuits and operable with or without a key to start or shut down the unit a steering wheel 18a to overide automatic steering; an accelerator 18b to overide automatic speed controls; and a brake 18c to provide added control. It should be noted that the automatic transport system can be designed in two configurations one with a steering wheel column 15 and where a driver 18e can be optional where a system can operate in a fully automatic mode where there is no need of manual acceleration, or manual braking, or manual steering because the automated transport system has automated steering mechanisms, automated acceleration and automated braking and shutdown including fully automated pick up and unloading capabilities. Also shown is a hitch 58.

FIG. 4A depicts a manufacturing cell to cell automatic transport system with multiple platforms and table top access for multiple positional access and exchange of parts for manufacturing operations from one manufacturing cell to another with electromechanical, pneumatic, and or hydraulic robotic transfer means that can load and unload manufactured parts from multiple platform areas and from the automatic-transport system's table top access having secure lockable holding areas 22; lock down closure means or doors 20a; wheels 12; suspension means 14; and one or more platform bays 2.

FIG. 5 depicts a “non-motorized dockable payload wagon” version of the automatic-transport system 1 with “n” number of platforms 2, each having weight sensor(s) 3, said platforms designed for the placement of items 4 of different sizes where cargo can be released by a code being entered. Said transport system is further comprised of a circuit control system 6 that contains logic to control the system and an electronic or a combustion driven motor 7, a wireless communication port 8, a paint spraying system that can paint a line on the ground 9 that the automatic-transport system can follow, a waterproof tape-laying system 10 that the automatic transport system can lay on the floor or ground so that the transport system can later follow, a docking-locking system 11 that is designed to lock to a pin cemented to the ground upon arriving to a destination; weight sensors 13 for every platform bay; forward-and-reverse-looking scanners 13 for reading taped or painted lines and or barcodes in designated areas for following a path and for resetting area coordinates to give the automatic-transport system location information; forward and or reverse obstacle avoidance sensor(s) or scanner(s) 13a; cargo scanners 13b; a suspension system 14; with wheels 12 designed to go over uneven terrain, ditches, bumps, steps, etc.; a steering control system 15; a LCD or other Information Display Unit 16; a manual control panel 17; GPS circuits, with transmission and receiving antennae and RF receiving and transmitting modulation circuits 18; a USB port or other computer port 18d and a hitch 58.

FIG. 5A depicts a “non-motorized dockable payload wagon” version of the automatic-transport system 1 with “n” number of platforms 2, each having weight sensor(s), said platforms designed for the placement of items 4 of different sizes areas equipped with optional electromechanical transfer means 5 for grabbing cargo. Said transport system is further comprised of a circuit control system 6 that contains logic to control the system and an electronic or a combustion driven motor 7, a wireless communication port 8, a paint spraying system that can paint a line on the ground 9 that the automatic-transport system can follow, a waterproof tape-laying system 10 that the automatic transport system can lay on the floor or ground so that the transport system can later follow, a docking-locking system 11 that is designed to lock to a pin cemented to the ground upon arriving to a destination; weight sensors 13 for every platform bay; forward-and-reverse-looking scanners 13 for reading taped or painted lines and or barcodes in designated areas for following a path and for resetting area coordinates to give the automatic-transport system location information; forward and or reverse obstacle avoidance sensor(s) or scanner(s) 13a; cargo scanners 13b; a suspension system 14; with wheels 12 designed to go over uneven terrain, ditches, bumps, steps, etc.; a steering control system 15; a LCD or other Information Display Unit 16; a manual control panel 17; GPS circuits, with transmission and receiving antennae and RF receiving and transmitting modulation circuits 18; a USB port or other computer port 18d and a hitch 58. Said transport system has “n” number of platform bays each having “n” number of roller wheels 60 and a slotted track 61 that allows primary and secondary barriers to rise up from the floor through slotted tracks 63 to secure cargo contents also having a track system rail 53 to allow the telescoping portion of the electromechanical, pneumatic, and or hydraulic robotic transfer mechanism 5 having scanning means to position transfer mechanisms and to sense the type of cargo to select the type of transfer mechanism(s) to move about the length of the transport system to move from platform bay to platform bay whereas the electromechanical, pneumatic, hydraulic, robotic transfer mechanisms 50 and 51 then turn on the gear 50a to pivot choose an appropriate transfer mechanism in deluxe models from as in a carousel exchange model (this component is shown in FIG. 12) or to go to an exchange area and automatically exchange systems or to prompt staff so that they may manually exchange transfer mechanisms that the system may load or unload cargo 4 unto or off of the transport system as needed and determined by sensor(s) 13 placed throughout the transport system. It should also be noted that the transfer mechanism(s) 50 and 51 (shown in phantom) can be thus exchanged to accommodate different types of cargo items 4.

FIG. 6 depicts a “secure mail-delivery, hard copy document delivery or a computer media supply delivery or other parts supply delivery” version of the automatic-transport system 1 with “n” number of platforms 2, said platforms designed for the placement of one or more boxes, diskettes, tapes, bins or files or boxes or parts, pieces of cargo, boxes, pallets, etc. 20, of different sizes and electromechanical transfer means 5 for grabbing the item(s) and or cargo to load or unload them from said automatic-transport system into lockable compartments having electromechanical door systems that automatically open and close to co-function with the transfer systems for loading and unloading operation(s) and or to open or close in models for loading and unloading operations for “secure mail delivery” models not having mechanical transfer mechanisms. Said transport system is further comprised of a circuit control system 6 that contains circuits to capture the radio frequency of a garage door opener to use it to open the door, an internal clock and the logic to control the system, circuitry to set the day(s) of the week and the times when to make deliveries or to overide the same through wireless or wired means 8 and RF modulation circuits 18, other operational circuitry; and an electronic or a combustion driven motor 7, a wireless communication port 8, a paint spraying system that can paint a line on the ground 9 that the automatic-transport system can follow, a waterproof tape-laying system 10 that the automatic transport system can lay on the floor or ground so that the transport system can later follow, a docking-locking system 11 that is designed to lock to a pin cemented to the ground upon arriving to a destination; forward-and-reverse-looking scanners 13 for reading taped or painted lines and or barcodes in designated areas for following a path and for resetting area coordinates to give the automatic-transport system location information; forward and or reverse obstacle avoidance sensor(s) or scanner(s) 13a; cargo scanners 13b; a suspension system 14; with wheels 12 designed to go over uneven terrain, ditches, bumps, steps, etc.; a steering control system 15; a LCD or other Information Display Unit 16; a manual control panel 17; GPS circuits, with transmission and receiving antennae and RF receiving and transmitting modulation circuits 18; a USB port or other computer port 18d; an ignition circuit 18e connected with wireless receiving circuits and operable with or without a key to start or shut down the unit; an optional steering wheel 18a to overide automatic steering; an optional accelerator 18b to overide automatic speed controls; and an optional brake 18c to provide added control. It should be noted that the automatic transport system can be designed in two configurations one with a steering wheel column 15 and where a driver can be optional where a system can operate in a fully automatic mode where there is no need of manual acceleration, or manual braking, or manual steering because the automated transport system has automated steering mechanisms, automated acceleration and automated braking and shutdown including fully automated pick up and unloading capabilities. Also shown is a hitch 58.

FIG. 7 depicts the “automatic-transport system 1 with “n” number of platforms 2, each having weight sensor(s) 3, said platforms designed for the placement of one or more boxes, diskettes, tapes, bins or files or boxes or parts, pieces of cargo, boxes, pallets, etc. 4, of different sizes and optional electromechanical transfer means 5 (not shown in this FIGURE) for grabbing the item(s) and or cargo to load or unload them from said automatic-transport system into “n” number of platform bays. Said transport system is further comprised of a circuit control system 6 that contains circuits to capture the radio frequency of a garage door opener to use it to open the door, an internal clock and the logic to control the system, circuitry to set the day(s), of the week and the times when to make deliveries or to overide the same through wireless or wired means 8 and RF modulation circuits 18, other operational circuitry; and an electronic or a combustion driven motor 7, a wireless communication port 8, a paint spraying system that can paint a line on the ground 9 that the automatic-transport system can follow, a waterproof tape-laying system 10 that the automatic transport system can lay on the floor or ground so that the transport system can later follow, a docking-locking system 11 that is designed to lock to a pin cemented to the ground upon arriving to a destination; forward-and-reverse-looking scanners 13 for reading taped or painted lines and or barcodes in designated areas for following a path and for resetting area coordinates to give the automatic-transport system location information; forward and or reverse obstacle avoidance sensor(s) or scanner(s) 13a; cargo scanners 13b; a suspension system 14; with wheels 12 designed to go over uneven terrain, ditches, bumps, steps, etc.; a steering control system 15; a LCD or other Information Display Unit 16; a manual control panel 17; GPS circuits, with transmission and receiving antennae and RF receiving and transmitting modulation circuits 18; a USB port or other computer port 18d; an ignition circuit 18e connected with wireless receiving circuits and operable with or without a key to start or shut down the unit; an optional steering wheel 18a to overide automatic steering; an optional accelerator 18b to overide automatic speed controls; and an optional brake 18c to provide added control. It should be noted that the automatic transport system can be designed in two configurations one with a steering wheel column 15 and where a driver can be optional where a system can operate in a fully automatic mode where there is no need of manual acceleration, or manual braking, or manual steering because the automated transport system has automated steering mechanisms, automated acceleration and automated braking and shutdown including fully automated pick up and unloading capabilities. Also shown is a hitch 58.

FIG. 8 depicts an automatic transport system with multiple platform bay area(s) to handle and load or unload cargo having an optional driver seat and steering system and optional accelerator and braking system whereby models can be developed that have their own automatic steering, acceleration, and braking system(s), also having electromechanical, pneumatic, and or hydraulic robotic transfer mechanisms 5 for loading and or unloading cargo comprised of extending support means 52; lift components 50a, 50, and robotic grasping attachments 51 which can vary from model to model. Also shown are wheels 12; scanners 13; platform bay(s) 2; and a an electric or a combustion motor 7.

FIG. 9 depicts an automatic transport system with at least one platform bay area mounted in front of the automatic transport system to load or unload cargo having an automatic steering system, accelerator and braking system also having electromechanical, pneumatic, and or hydraulic robotic transfer mechanisms for loading and or unloading cargo showing a transport system having “n” number of platform bays each having “n” number of roller wheels 60 and a slotted track 61 that allows primary and secondary barriers to rise up from the floor further showing the base 5 of the electromechanical, pneumatic, and or hydraulic robotic transfer mechanisms for loading and or unloading cargo and components of the transfer mechanism(s) 50; including the robotic grasping mechanism(s) 51; grasping a drum 4; further shown are wheels 12; and a floor of the transport system showing one or more platform bay(s) for loading cargo.

FIG. 10 depicts a electromechanical, pneumatic, hydraulic and or robotic grasping mechanism designed to load or unload specific types of cargo items showing an exchangeable robotic transfer mechanism 50; a drum 4; and a robotic grasping arm 51 designed for drums which can be replaced with any type of grasping mechanism for any type of cargo or item that needs to be handled including custom application(s) (also for manufacturing applications). The transfer arm is put in position to grab an item for loading or unloading and can turn 360 degrees to position a cargo item as is needed to position an item for loading or unloading requirement(s).

FIG. 10A depicts an electromechanical, pneumatic, hydraulic and or robotic grasping mechanism 5 picking up a cargo item 4 and either loading it or unloading it, grasping it with exchangeable robotic arms 51 that are connected to an exchangeable robotic transfer mechanism 50 that pivot and turn about on a gear 50a to position cargo in desired angles where the transfer mechanism can extend and be supported by support means 52 as it telescopically extends or retracts to position cargo as it loads and or unloads cargo unto and or off the transport system.

FIG. 10B depicts a electromechanical, pneumatic, hydraulic and or robotic grasping mechanism 5 either placing the cargo item unto the transport system, or getting ready to pick up the cargo item to unload it with support means 52, a gear 50a to position cargo in desired angles where the transfer mechanism can extend and be supported by support means 52 as it telescopically extends or retracts to position cargo as it loads and or unloads cargo unto and or off the transport system and an exchangeable robotic transfer mechanism 50 grasping and holding a drum 4 resting on a platform bay 2 of the transport system.

FIG. 10C depicts a cargo item 4 after it has been placed unto the transport system, and a primary barrier 62b and a secondary barrier 62a have been raised to secure it in place for transport. Also shown are further slots 63 in the track 61 on the platform bay floor where additional primary and secondary barriers can rise up from the floor to secure additional cargo items as they are loaded for transport and lowered for unloading operations [this drawing shows no transfer mechanism(s)].

FIG. 10D depicts a cargo item 4 after it has been placed unto the transport system, and a primary barrier 62b and a secondary barrier 62a have been raised to secure it in place for transport. Also shown are further slots 63 in the track 61 on the platform bay floor where additional primary and secondary barriers can rise up from the floor to secure additional cargo items as they are loaded for transport and lowered for unloading operations where there are transfer mechanism(s) that have been moved to the next platform bay position after placing the cargo unto the transport system to park the transfer system in an empty designated platform bay or to disengage from the cargo.

FIG. 11 is a top plan view of the cargo tranfer system showing a robotic transfer mechanism grasping and loading or unloading cargo unto or off of the transport system bed showing electromechanical, pneumatic, hydraulic and or robotic grasping mechanisms designed to grab cargo and directionally turn and rotate cargo 0-360 degrees as desired and determined by programmable logic to load and unload cargo into and out of the transport system.

Standard operation to load a transport system from front to back would be to extend the robotic transfer mechanism to grab an item turn it 90 degrees to pull it aboard the transport system release it and then disengage the robotic transfer mechanisms by releasing the items and exiting towards the back of the vehicle or by exiting from the most logical path allowed.

FIG. 12 depicts a carousel exchange system of of “n” number and size and shape to contain various electromechanical, pneumatic, hydraulic and or robotic-type grasping mechanism(s) 51; 51a; 51b; 51c; 51d; 51e; 51f; 51g; and so on designed to load or unload different types of cargo in and out of the automatic transport system models that can automatically connect to and exchange themselves to the exchangeable transfer mechanism section of the transfer mechanism where the exchangeable robotic grasping mechanism can connect to the system through manual or automatic means.

FIG. 13 is a logic block diagram of the Load/Unload Circuit (LU) illustrating components of the “LOAD/UNLOAD CIRCUIT having a selective operating mode logic module whereby the logic allows the selection of operating modes through the: “Operating Mode Select Logic: Manual, Programmed, Or RF” 150; where the logic allows the selection of various or a single: “Programmed Lift(s) For Loading And Unloading Cargo Onto Transport” 151. Further logic includes selectable “Programmed Robotic Transfer Mechanisms For Positioning Cargo On Transport” 152 and: “Programmed Barriers For

Securing Cargo On Transport Including Activation Of Lock Down Mechanism(s), Reset And Park Robotic Lift Transfer Mechanism(s)” 153 having “X” width and “Y” height that can be electromechanically activated to rise up from the floor and come into contact with the cargo and secure cargo into place, that slide on tracks within the floor of the platform bays to position themselves against cargo after cargo has been loaded that are put in place and raised in their position(s) after scanners scan the cargo or after the automatic transport system receives input about the cargo for proper positioning of the barrier(s) and also to deactivate the barrier(s) or lower them for unloading operation(s). Further logic includes: “Memory With Security Codes, Lift Logic, Load And Unload Logic, Programmed Operations, Barcode Decoders, Special Instructions And Cargo Information” 154 that is also provided in the LOAD/UNLOAD CIRCUIT (LU). Further logic includes: “Scanner(s) For Barcodes, Sensing Cargo, Cargo And Transport Positions & Object Avoidance” 155 that are fed into the LOAD/UNLOAD CIRCUIT (LU). Yet further logic includes a: “Lift Sensor For Size, Weight And Position Detection” 156 that is fed into the LOAD/UNLOAD CIRCUIT (LU). Still yet further logic includes a: “Robotic Transfer Mechanism Sensor For Weight And Position Detection On Transport Surface For Proper Positioning Of Cargo” 157 that is also fed into the LOAD/UNLOAD CIRCUIT (LU). All these logical and circuit components are illustrated in FIG. 13.

FIG. 14 is a flow chart diagram for Loading And Unloading illustrating operational and procedural aspects of the automatic transport system including positioning the automatic transport system by the cargo; the choosing of lift devices, scanning cargo to receive input on cargo size or handling requirement(s) or receiving data about cargo; the loading and unloading of cargo through lift devices; the positioning and securing of cargo items; the securing of cargo items through raiseable barriers, the activation of lock down mechanisms; the resetting and parking of robotic lift transfer mechanisms after loading and or unloading operations; the sending of status of load or delivery information; and the function of sending the automatic transport system to the next destination.

FIG. 15 is a logic block diagram of the Propulsion Path Circuit depicting a logic and a circuit diagram illustrating logic and circuit components of the PROPULSION PATH CIRCUIT“having an: “Ignition Module” 161 used for starting the automatic transport system that can be started through manual mechanical means by entering a key or through wireless or wired downloadable means through a port, and or through programmable automatic means through date/time circuits after programming. Further logic and circuitry includes a module that allows the automatic transport system to operate by selecting a mode in which to operate and which can be changed at any time entitled: “Select Mode: Manual, Programmed, Painted Path Or RF Remote Control” 162. Connecting from the select mode further logic and circuitry includes a module called: “Painted Path Control: Steering, Speed And Direction Control With Paint Sensitive Sensors” 163. Connecting from the select mode further logic and circuitry includes: “Manual Path Control: Steering, Speed And Direction Control” 164. Connecting from the select mode further logic and circuitry includes: “Programmed Path: GPS Coordinates And Steering, Speed And Direction Instructions Loaded From ROM” 165. Connecting from the select mode further logic and circuitry includes: “RF Controlled Path: Steering, Speed And Direction Control” 166. Further logic and circuitry includes connections to further logical components entitled: “Garage Door Logic; Opens Closes Garage Door As Needed” 154A which is not limited to garage doors, where said garage door can be any electromechanical door system or any type of closure system where the transport system can be stored and automatically released through logic controls 154A where said programmable logic is utilized to open a garage door or an electromechanical door or other closure system where the transport system may be stored in a storage area upon the automatic transport system being activated for use to allow the transport system to proceed to a destination after a sufficient time delay to allow for the door to open and or to mobilize the automatic transport system to proceed to a destination for loading or unloading operations after receiving optional input from the: “Garage Door Sensor Input” 154B which tells the automatic transport system that the path is clear that the transport system may proceed to its destination. After the automatic transport system completes its journey it may then optionally return to the garage or storage area to its original area when it may then send a RF signal and close the electronic garage door, the electromechanical door, the other closure system, or gate to secure the transport in its storage area by having the: “Garage Door Logic; Opens Closes Garage Door As Needed” 154A send a signal through the built in: RF wireless RF transmitter entitled: “Garage Door Opener Or RF Transmitter Output” 154C. It should be noted that object avoidance can be utilized in many ways to determine if there is an object in the automatic transport system's path whereby logic can be included to direct the to direct the transport system to proceed around the obstacle or to direct the transport system to return to the sending location and report a message to staff on the panel of the transport system or through wireless means to the staff that an obstacle was found in the path and that the transport system returned to send location without completing task(s). Further, obstacle avoidance and logic in the transport system can determine where the transport system has to go to park itself in a secure area such as where it would park itself normally and close a garage door or other electromechanical door, gate or other closure mechanism having the intelligence to know where the coordinates of this location is through painted lines that it follows, or through GPS coordinates in memory and when approaching said coordinates after loading or unloading operations to park in said location it uses obstacle avoidance sensor(s) to determine whether or not said door is closed. If said door is closed when returning to store and park itself the transport system will use internal logic to automatically momentarily stop and engage RF transmission circuits to open the lockable electronic garage door or other electromechanical door(s), gates, or closure systems and then proceed into the garage or storage location, park in its designated spot, dock and lock unto its locking pin so it cannot be moved, send another RF signal to close the garage door or other electromechanical door, gate or other lockable closure system to seal off the storage area, and then shut down the unit or put it in standy mode. Further logic and circuitry includes connections to “Steering Servo Motors” 168 that can be overridden in models equipped with steering wheels, with accelerators, and braking systems, that can be driven with a driver, (however other models can be designed to move from one destination to another automatically as programmed or as fed direction(s) from wireless means without a driver). Further logic and circuitry includes connections to: “Speed Control Motors Including START and STOP” 169 that serve to control the speed and the braking functions of the transport system models. Further logic and circuitry includes connections to: “Forward/Backward Control Transmission” 170 that allow the transport system to be controlled to operate in a forward or in a backward or a reverse motion. Further logic and circuitry includes a: “Decision ROM For Avoidance Of Obstacle With Overide Capability For Control Of Transport System” 172, having at least one “Obstacle Sensor” in the front or in the rear of the vehicle to look ahead in either direction that feeds information to the “Decision ROM” 172 for decision making to protect the automatic transport system's course. All these logical and circuit components are illustrated in FIG. 15.

FIG. 16 is a logic block diagram of the Memory Management Circuit depicting a logic and circuit diagram illustrating logic and circuit components of the “MEMORY MANAGEMENT CIRCUIT” having a module containing: “I/O Circuits For Path Programs, Path Recording Barcode Information, Remote Instructions, Cargo Data, Deliver Status, Updates, RF, And Manual Signals” 158. Further logic and circuits include a: “Date & Time Circuit” 159 utilized for scheduling automated programming and for running of the transport system for automated destination planning and for automated pick up and delivery of cargo items to and from destination(s) with logic and circuitry for date/time stamping and to report the date/time when the cargo is delivered through the date/time circuit or to report the status where the cargo is through GPS coordinates, or by reporting where the transport system is by reporting where it is by scanning and reporting what portion of a painted or taped line it is reading coordinates at from a starting point at any point in time and utilizing date/time stamping to report said status to combine location with a date and time. Yet further logic and circuits include: “Memory Locations” 160 within the MEMORY MANAGEMENT CIRCUIT comprised of memory I/O, circuitry, functions, and memory allocations including but not limited to: a) DATE & TIME INFORMATION, GPS COORDINATES FOR WAREHOUSE & PATHS, OR MAPPED AREA, c) SPECIAL INSTRUCTIONS, d) INDIVIDUAL CARGO DATA, e) BARCODE INFORMATION & DECODING ROM, f) EPROM WITH PATH PROGRAMS AND GARAGE DOOR LOCATIONS, g) MULTIPLE PACKAGE DELIVERY CODES, h) WAREHOUSE CARGO DATA, i) SECURITY CODES & DECODING ROM, j) PATH RECORDING DATA, k) DELIVERY STATUS & UPDATES, I) USER SPACE WITH SPECIAL PROGRAMS, m) INSTRUCTIONS FOR LIFT LOGIC INCLUDING INSTRUCTIONS FOR LOCK DOWN MECHANISMS, n) ADDITIONAL INSTRUCTIONS, o) ETC. All these logical and circuit components are illustrated in FIG. 16.

FIG. 17 is a plan view of the present invention depicting a programmable digital assistant or a wireless remote designed to record GPS coordinates over time and save them for downloading to the automatic-transport system either through a wired connection or through wireless means whereas the view depicts a programmable digital assistant designed to record GPS coordinates over time and save them for downloading to the automatic-transport system either through a wired connection or through wireless means comprised of a programmable digital assistant or a wireless remote RF transmitter shown in FIG. 17; having a transmitting and receiving antenna 25; a LCD readout 26 for operational commands and for interfacing with the automatic-transport system; a record button 27 used to start recording and saving global positioning satellite coordinates over time as the PDA unit travels through an area; PDA or remote interface buttons 29 (shown in FIG. 18) that allow a user to call up software and a software-based alphanumeric keypad/keyboard on the PDA LCD to communicate with the automatic-transport system; a save button 28 that saves the automatic-transport ID number after it is entered in successfully; a start-automatic-transport-unit button 30 designed to start the automatic-transport system; a send button 31 that sends the saved GPS coordinates and the path(s) the automatic-transport unit should follow to its destination(s); an on/off button 32 to power-up the programmable digital assistant; a cancel button 33 to cancel an operation or a command; a scroll button 34 to scroll through commands designed to operate and interface with the automatic-transport system; a USB or other computer port 35 to download GPS coordinates to the automatic-transport system; a battery 36 to power the PDA; an AC/DC adapter 36a as alternate power means for providing power to the PDA and or to recharge the unit. FIG. 18 is a plan view of the present invention depicting a programmable digital assistant or a wireless remote designed to record GPS coordinates over time and save them for downloading to the automatic-transport system either through a wired connection or through wireless means whereas FIG. 8 is a plan view of the present invention depicting a remote control or a PDA designed to control and interface with the automatic-transport system either through a wired connection through a USB or other port 35 or through wireless means comprised of a remote control unit or a PDA designed to capture and record GPS coordinates; a transmitting and receiving antenna 25; a LCD readout 26 for operational commands and for interfacing with the automatic-transport system; a record button 27 used to start recording and saving operational coordinates over time as the automatic-transport unit travels through an area; pushbutton control interface buttons 40 “a-z” and “0-9” that allow a user to enter identification and commands to communicate with the automatic-transport system; an ID program pushbutton 41 that allows the user to enter into a program mode which allows a user to enter an ID for the automatic transport system; backward/forward buttons 42 that allow the user to enter the next letter when entering the automatic-transport ID in program mode or to back up and correct a mistake; a save button 28 that saves the automatic-transport ID number after it is entered in successfully; a start-automatic-transport-unit button 30 designed to start the automatic-transport system; a send button 31 that sends the saved GPS coordinates and the path(s) the automatic-transport unit should follow to its destination(s); an on/off button 32 to power-up the programmable digital assistant; a cancel button 33 to cancel an operation or a command; a scroll button 34 to scroll through commands designed to operate and interface with the automatic-transport system; a USB or other computer port 35 to download GPS coordinates to the automatic-transport system; a battery 36 to power the PDA; an AC/DC adapter 36a as alternate power means for providing power to the PDA and or to recharge the unit.

Other components of the automatic-transport system include a wagon-like automated-transport system having at least three (3) or (4) four wheels per platform area or automated transport system. Where (1) or two (2) wheels of the automated-transport system will be used for steering the automated-transport system attached to an electromechanical steering system controlled by a circuit designed to follow a line, no matter how it is drawn, in direction “X or Y”, forward or reverse, for length “Z” through scanners installed on the bottom and or the front/back, bottom, and or side(s) of the unit, and or by employing GPS coordinates and directions without the need for employing the use of lines and scanners, and where the other two wheels will be used for stability and to make it mobile. Furthermore, further components include mechanisms that will allow an automated-transport system to lock its wheels as it is moving so as not to slide down a slope as it is moving things if the transport system is going up or down a gradient.

Other components of the automatic-transport system include logic circuits that will allow people or contents to be moved from one location to a designated area by a user pressing a button on the unit to send it in manual mode, or in automatic mode when the unit is filled to capacity a weight sensor will activate the unit to start the electromechanical or combustion motors that will move the wheels of the unit to follow the taped line on the pavement or the painted line in the direction chosen (to designated area “X”, back to loading area “Y”, forward or reverse) as chosen in the programming of the automated-transport system to a designated area, for “Z” length away from the loading area, or by using GPS coordinates to go to a location.

Other components of my invention is to provide an electronic device with logic circuits having built-in GPS functionality that will automatically record GPS coordinates over time as it is moved plotting the location of where it traveled to allow the automatic programming of the automatic-transport system so a path can be automatically downloaded to the automatic-transport system so the automatic-transport system can then move to follow those coordinates and walk through a manufacturing plant, manufacturing cells, quality control cells, testing cells, painting cells, process cells, packaging cells, warehousing, offices, mail routing, mail rooms, through military establishments, for field operations, for military, battlefield, commercial, intelligence or other operations to allow the delivery of a person, people, or items or cargo on the platform(s) of the automatic-transport system just like the electronic device was walked through within a certain programmable settable deviation.

Other components of my invention include logic circuits to provide programmability where the automatic-transport system can be programmed to recognize when it is in a “Loading Zone” and to travel a certain distance “Z” from a “Loading Zone” to go to a “Destination Zone”, then proceed to return to the “Loading Zone” or to proceed further to another “Zone” by following a line that is either painted on the floor or taped on the floor.

Other components of my invention is to provide logic circuits in the automatic-transport system that has the ability to select a direction from a fork in the road as selected and programmed in memory where the tape it reads or the line it reads on the floor has a multiplicity of lines (depending on the cargo it is carrying).

Other components of my invention include the construction of an automatic-transport system to be constructed that will allow at least one platform cargo area to be moved from one location to another. Said platform area can be constructed in a fashion to allow the receipt of items to be placed upon the automatic-transport system or for one or more people to step and stand on the platform to be moved from one location to another depending on how large the automated transport system platform is made and how sturdy it is made to accommodate the weight of items that will be placed upon the platform area. On models where the platform will be utilized for the loading and unloading of pallets the automatic-transport system will have electromechanical and or hydraulic or pneumatic means to drop the pallets when commanded to do so when the automatic transport system reaches its designated unloading area. Alternatively, the automatic-transport system can go into hold mode when it reaches its designated destination and alert the manager, an employee, or other people that it has arrived through wireless communications to a computer via email, or it can just drop of contents and return back to the loading area automatically, or wait to be sent back by user interaction after entering a security code.

On other systems where the automatic-transport system is used for moving waste, or garbage cans, scrap or recyclable materials, contaminated waste, radioactive materials, chemicals, bio-hazardous waste or other materials, boxes or canisters, or drums, or where items are valuable, special electromechanical holding arms can be utilized that will lock the items in the automatic-transport system while it is moving and it will release the items from the automatic-transport system only upon a security code being triggered.

Prior to such entering of a security code no release of the items will be made. When the security code is entered a further functionality of the system allows wireless connection to interface with a company's software system to update warehousing records that items are received and now in stock in the warehouse, furthermore the items will be locked in place in the automatic-transport system until they get to their destination for added security while the automatic-transport system is moving. The security code can be entered automatically by the system once it has traveled to its destination after traveling “X” or “Y” distance, forward or reverse, of length “Z” as it was programmed to do so, or it will unlock its contents after a user, an employee or manager with authority enters a security code.

Other components of my invention will allow the creation of different automatic-transport systems to be made that can scan and follow lines drawn or painted on pavement or asphalt or read tape glued on pavement or asphalt and travel from a start position to an end destination to deliver items or people from one location to another, and or by employing GPS, (global positioning system technology coordinates and trail navigation techniques where one can draw a path precisely how they would like to travel utilizing GPS coordinates mapping).

Other components of my invention include an automatic-transport system with an array of sensors and logic circuits that will keep the automatic-transport system on top of the painted line or the taped line and to follow it while the automatic-transport system is moving to its destination(s).

Other components of my invention include logic circuits with the functionality to allow the automatic-transport system to make a choice at each destination or at each stop to select from a series of directions it can go to from each stop it makes through GPS coordinates stored in memory for the next location it will travel to or by following a certain painted or taped line on the floor through scanner means that it is programmed for. These coordinates or choices can be changed on the fly manually by an interface on the built-in automatic-transport system's control unit or through wireless means through a computer remotely. The automatic-transport system can be programmed to drop people off going through “X” number of nodes or destination(s) and it can be programmed to return to any destination or to proceed to another destination through line scanning means or through GPS coordinate traveling means.

Other components of my invention include an automatic-transport system with platform support for moving people or objects from one location to another with optional support structure(s) to accommodate the securing of objects to be placed into or unto the platforms or further support structures for people to support themselves while traveling on the platforms such as something to hold onto when the platform is moving, or something to sit on for extra comfort.

Other components of my invention include an automatic-transport system with a wireless communication port that will allow an interface to computers and a software interface that will allow accounting records to be updated and emails to be sent out to managers and employees and others that will update records when cargo or people have arrived at a certain destination or node in a plant or warehouse or other area as they occur.

Other components of my invention will allow an automatic-transport device to be developed for home use for the consumer that will either sit on the side of their garage, or in their garage, or somewhere outside a person's home that as in many suburban settings an automatic-transport system can be utilized to automatically deliver garbage, yard waste and recyclable items to the front of a person's driveway, or from their back door or from their garage to their alley, so that waste haulers can take the garbage away automatically.

Other components of my invention include an automatic-transport device that will have a series of platforms in a consumer version that will allow consumers to place at least one garbage can on each platform unit, each platform unit having a weight sensor to determine if the garbage can is empty. Further components include logic circuits that allow the consumer to program the date and time he or she wants the unit to put the garbage out.

The automatic-transport system has an internal clock that keeps track of the time and date. Furthermore, the automatic-transport system also has logic circuits that enable it to use a radio transmitter that will trigger the garage door opener and open it automatically, with a time delay to wait until the garage door opens completely before the automatic transport system travels out to the front of the driveway or to the alley so the automatic-transport system can travel outside of the garage or to the designated drop-off area unattended following the line or the tape glued to the pavement or the asphalt driveway.

Other components of my invention is to provide a logic circuit that will allow the automatic-transport device to return back inside the garage where it might be kept for safe keeping and close the garage door by transmitting a remote wireless signal to the garage door opener via remote means after the automatic-transport system returns to its loading area back inside the garage (where the automatic-transport system might be kept in home use for loading) after dropping-off the garbage in front of the driveway or at its designated drop-off area in the alley for the waste haulers.

Other components of my invention include logic circuits in the automatic-transport system with the use of weight sensors that can sense which of the platforms in the chain of platforms in the automatic-transport system are empty. When the automatic-transport system reaches its destination, if the garbage can is empty it is not ejected, but rather it is taken back to the garage, or to the original loading area. It is proposed that consumers use and fill the first can first, the second can second, the third can third, and so on when filling them in order for proper operation that the automatic-transport system may drop off garbage cans one next to another when reaching its destination so that it would make things easier for waste haulers, and so things will look neater at the end of the driveway or in the alley (this is illustrated in the drawings).

Other components of my invention is to provide an automatic-transport system in various models where one automatic-transport system can have multiple platforms built into it with weight sensors of “X” size, and “Y” shape, and also in alternative versions where a chain of platforms can be connected together so that a consumer or a commercial user can add or subtract as many platforms as he or she may require per run depending on how many garbage cans or pallets or platforms he or she wants to move at a time. In the models where a chain of platforms are used the automatic-transport system will have the intelligence to sense how many platforms are connected together, and it will release only the items above a certain weight if programmed to do so, or all the items, as desired upon reaching its destination as previously mentioned, and the release mechanisms will work on every platform as programmed, no matter how many or how few platforms are connected together. The automatic-transport system will work to release all items chained together, every item above a certain weight, or every item brought to the destination on every platform. Another object of my invention is to provide an automatic-transport system that can be used to move objects in manufacturing lines from one operation cell to another. The wheels of the automatic-transport system can be modified to be installed on a track, or to be installed in a geared track, or the automatic-transport system can travel from one location to another on the manufacturing floor with rubber tires, or with rubber tracks, or other traction means.

Other components of my invention include logic circuits and functionality and controls in an automatic-transport device for consumer use to deliver recyclable disposal bins, garbage cans, disposal containers, plastic bags, paper leaf bags, etc. from a loading area to a designated area such as the end of a driveway or to an alley for pick-up by waste haulers triggered for movement after a consumer manually triggers the automatic-transport system to deliver the garbage for waste removal to the programmed area, and return the automatic-transport system back to its loading area, where the automatic-transport system has the option to either send a remote transmission to open the garage door, or where the consumer can set the automatic-transport system to be in total manual mode where the consumer sets the system to make sure he opens the garage door and then he manually triggers the automatic-transport system to send the garbage out. In manual mode the automatic-transport system always returns to the designated loading area after dropping off the “recyclable disposal bins, garbage cans, disposal containers, plastic bags, paper leaf bags, etc.” at the programmed drop-off site or distance from the loading area.

Other components of my invention include circuit card(s) containing logic circuits for all of the functions mentioned in the objects and advantages of my invention. Other components of my invention include wireless communication means to interface with computers for updating accounting records when cargo or people have arrived at a certain destination.

Other components of my invention include a battery strong enough to drive the electronic motors that will drive the motors and the electronics of the automatic-transport system for the weight load(s) the automatic-transport system will be carrying, or combustion engines powerful enough to move the loads they will be carrying.

Other components of my invention include an automatic-transport system with scanning ability to not only be able to scan lines taped or painted on pavement or asphalt or roads, but to be able to scan bar codes or other symbols that can relate information to the automatic-transport system so that the automatic-transport system will know where it is and display that information on a display panel as programmed, and or so that information may be transmitted through the wireless communication port to a remote computer to tell a computer where the automatic-transport system is that cargo, or people have arrived at a particular destination.

In the GPS models, the automatic-transport system can always tell the display on the automatic transport system map where it is at any point in time, or GPS coordinates can be fed to a remote computer at all times to track where an automatic-transport system is at all times.

Other components of my invention include an automatic-transport system that includes platform support to move people or objects with motorized support within the same system and or add on wagon like components that can be hooked up to a motorized automatic-transport system in train-like fashion where non-motorized wagons can be pulled by a motorized automatic-transport system having all the features of the motorized version being connected to the motorized system and communicating and operating separately with electronics and functions similar to the main master automatic-transport system to perform similar functions at designated drop off areas to be triggered by the main master command control system to drop off contents as desired each non-motorized wagon-like system having optional mechanical transfer systems built-into the wagons so as to allow the functionality to drop off items at designated areas as desired.

Electromechanical Motors Or Combustion Motors Used To Move People Or Objects Placed On The Platforms Of The Automatic-Transport System. Scanners Used To Read Lines Drawn On Pavement So That The Automatic-Transport System Can Follow A Painted Line Or A Taped Line Course To Destination(s), And To Read Bar Codes To Report Where The Automatic-Transport System Is At Any Point In Time.

A Global Positioning Coordinate System Device That Will Enable A User To Download Path Data To The Automatic-Transport System So That The Automatic Transport System Can Travel To Programmed Destination(s).

A Steering Control System That Will Be Used To Turn The Automatic-Transport System To Follow GPS Coordinates As Downloaded Or To Follow Taped Or Painted Lines On The Pavement Or Factory Or Warehouse Or Office Floors Through Scanning Means. The Circuit Card(s) Employed By The Automatic-Transport System Contain All The Logic Circuits That Have The Functionalities Contained In The Objects And Advantages Of The Present Invention.

The Wireless Communication Port Is An Interface That Allows The Automatic-Transport System To Communicate With Remote Computers To Update Accounting Records, To Send Emails To Employees, Managers, And Other People As To The Arrival Of People, Cargo, Or Items To A Designated Area Through Built-In Logic And Or Software, And To Control Where The Automatic-Transport System Goes For Unattended Automatic Operation Via Computer Control.

The Built-In User Interface Allows A User To Manually Control The Automatic-Transport System Having Data-Entry Means And Or Control Means And Display Means To Control System Go To A Certain Location By Entering A Security Code As Pre-Programmed Or To Change It On The Fly. Electromechanical, Pneumatic, Or Hydraulic Release Mechanisms Are Used To Hold And Lock Down Cargo Or Items While They Are In Transport For Security Reasons And They Release Items Upon A Security Code

Being Entered Either Automatically When Reaching A Destination Or Upon A User Entering A Security Code.

Optional Support Structures Can Be Built-Into The Automatic-Transport System To Accommodate Cargo So Cargo Or Items Can Be Supported Better Or Handled More Efficiently Or To Make Their Handling More Secure. In The Case Of Moving People, Support Structures Can Include A Holding Bar Where A Person Or People Can Hold On To A Rail When The Platform Is Moving, Or Other Support Structures Such As Seating Can Be Provided.

The Locking System Consists Of A Locking Pin On The Automatic-Transport System That Mates With And Locks With A Pin That Is Cemented In The Ground Or In The Floor Of A Factory Or A Garage Or A Particular Destination Where The Automatic-Transport System Locks Down At When Programmed To Or When Completing A Run After Making A Delivery And Returning To A Loading Area So The Automatic-Transport System Cannot Be Stolen.

Electromechanical Motors Or Combustion Motors Used To Move People Or Objects Placed On The Platforms Of The Automatic-Transport System. The motors of the automatic-transport system are either electromechanical motors or combustion motors used to move people or objects placed on the platforms of the automatic-transport system of various sizes and torque and power/horsepower to handle different weight and size and type of payload requirements. The motors can be electromechanical or of combustion type and can be of different sizes and power depending on the weight they are to move.

Scanners Used To Read Lines Drawn On Pavement So That The Automatic-Transport System Can Follow A Painted Line Or A Taped Line Course To Destination(s), And To Read Bar Codes To Report Where The Automatic-Transport System Is At Any Point In Time. The scanners of the automatic-transport system are used to read lines drawn on pavement so that the automatic-transport system can follow a painted line or a taped line course to destination(s), and to read bar codes to report where the automatic-transport system is at any point in time.

The scanners can be of any size and shape and number can be placed in front, in back, on the sides, or on the bottom of the automatic transport system.

A Global Positioning Coordinate System Device That Will Enable A User To Download Path Data To The Automatic-Transport System So That The Automatic Transport System Can Travel To Programmed Destination(s). The Global Positioning Coordinate System Device enables a user to walk through an area to collect path data as the device moves and download path data coordinates to the automatic-transport system so that the automatic transport system can travel to and from programmed destination(s). The GPS system will allow a user to record multiple scenarios (i.e. a user can record multiple point movements such as: 1) Point A to Point B to Point C to Point D, or 2) Point A to Point C to Point D to Point A again etc., 3) Point A to Point B etc., 4) Point A to Point B to Point A again, etc. to any destination desired and or programmed by GPS.

A Steering Control System That Will Be Used To Turn The Automatic-Transport System To Follow GPS Coordinates As Downloaded Or To Follow Taped Or Painted Lines On The Pavement Or Factory Or Warehouse Or Office Floors Through Scanning Means. The Steering Control System is used to turn the automatic-transport system to follow GPS coordinates as downloaded or to follow taped or painted lines on the pavement or factory or warehouse or office floors through scanning means. The steering control mechanism can be composed of one wheel or two wheels that are used to turn the automatic-transport system in the direction that the scanners and logic circuits or the GPS coordinates tell it to go.

The Circuit Card(s) Employed By The Automatic-Transport System Contain All The Logic Circuits That Have The Functionalities Contained In The Objects And Advantages Of The Present Invention. The Circuit Card(s) employed by the automatic-transport system contain all the logic circuits that have the functionalities contained in the objects and advantages of the present invention. One or more circuit card(s) or chips can be used for developing the automatic-transport system.

The Wireless Communication Port Is An Interface That Allows The Automatic-Transport System To Communicate With Remote Computers To Update Accounting Records, To Send Emails To Employees, Managers, And Other People As To The Arrival Of People, Cargo, Or Items To A Designated Area Through Built-In Logic And Or Software, And To Control Where The Automatic-Transport System Goes For Unattended Automatic Operation Via Computer Control. The Wireless Communication Port is an interface that allows the automatic-transport system to communicate with remote computers to update accounting records, to send emails to employees, managers, and other people as to the arrival of people, cargo, or items to a designated area through built-in logic and or software, and to control where the automatic-transport system goes for unattended automatic operation via computer control. The wireless port should be designed to allow interoperability to all forms of devices including personal computers, programmable digital assistants, cell phones, and other devices.

The Built-In User Interface Allows A User To Manually Control The Automatic-Transport System Having Data-Entry Means And Or Control Means And Display Means To Control System Go To A Certain Location By Entering A Security Code As Pre-Programmed Or To Change It On The Fly. The Built-in Interface Has Data-Entry Means And Or Control Means And Display Means To Control The Automatic-Transport System Go To A Certain Location By Entering A Security Code As Pre-Programmed Or To Change It On The Fly. The built-in user interface can be a control panel, a touch pad device, a touch-screen or some other type of data entry device and display that will allow a user to control and view the automatic-transport system's location at any point in time.

Electromechanical, Pneumatic, Or Hydraulic Release Mechanisms Are Used To Hold And Lock Down Cargo Or Items While They Are In Transport For Security Reasons And They Release Items Upon A Security Code Being Entered Either

Automatically When Reaching A Destination Or Upon A User Entering A Security Code. Electromechanical, Pneumatic, Or Hydraulic Release Mechanisms Are Used To Hold And Lock Down Cargo Or Items While They Are In Transport For Security Reasons And They Release Items Upon A Security Code Being Entered Either Automatically When Reaching A Destination Or Upon A User Entering A Security Code. The release mechanisms can either clamp onto around a portion of the cargo in a fashion where they would be difficult or impossible to remove, or they may enclose the cargo in a manner where they are encased and locked inside a shell casing while in transport to a destination for security reasons.

Optional Support Structures Can Be Built-Into The Automatic-Transport System To Accommodate Cargo So Cargo Or Items Can Be Supported Better Or Handled More Efficiently Or To Make Their Handling More Secure. In The Case Of Moving People, Support Structures Can Include A Holding Bar Where A Person Or People Can Hold On To A Rail When The Platform Is Moving, Or Other Support Structures Such As Seating Can Be Provided. Optional Support Structures Can Be Built-into The Automatic-Transport System To Accommodate Cargo So Cargo Or Items Can Be Supported Better Or Handled More Efficiently Or To Make Their Handling More Secure. Optional Support Structures Such As A Lockable Shell That Only Can Be Opened With A Security Code To Unlock The Contents Are Another Variation Of The Design With Optional Electromechanical Transfer Mechanisms To Drop Off Contents After Shell Is Unlocked. In The Case Of Moving People, Support Structures Can Include A Holding Bar Where A Person Or People Can Hold On To A Rail When The Platform Is Moving, Or Other Support Structures Such As Seating Can Be Provided. Various models of automatic-transport systems can be produced with various hand rails and seating systems including different models having different support structures to handle different pallets, drums, bins, hazardous waste, office and cargo with special manufacturing requirements.

The Locking System Consists Of A Locking Pin On The Automatic-Transport System That Mates With And Locks With A Pin That Is Cemented In The Ground Or In The Floor Of A Factory Or A Garage Or A Particular Destination Where The Automatic-Transport System Locks Down At When Programmed To Or When Completing A Run After Making A Delivery And Returning To A Loading Area So The Automatic-Transport System Cannot Be Stolen. The Locking System Consists Of A Locking Pin On The Automatic-Transport System That Mates With And Locks With A Pin That Is Cemented In The Ground Or In The Floor Of A Factory Or A Garage Or A Particular Destination Where The Automatic-Transport System Locks Down At When Programmed To Or When Completing A Run After Making A Delivery And Returning To A Loading Area So The Automatic-Transport System Cannot Be Stolen. Male and female components of a locking system that mechanically physically lock and unlock together upon contact when the automatic-transport system comes into contact with a pin mounted or cemented to a wall or the floor or the ground are proposed. Proposed is a barcode that can be scanned by the automatic-transport system that tells the system to lock-down on the pin when it comes in the area of the barcode where the lock-down pin is so the automatic-transport system can lock itself down.

Note: In all models of the transport system it should be understood that the transfer mechanisms park themselves in a designated platform bay area or in an area that will not interfere with cargo or in the operation with other transport functions when not performing load or unload operation(s).

The interconnections of the main components and the subcomponents of the automatic-transport system are as follows:

The automatic-transport system is comprised of a number of wagon-like components designed to transport people or objects and to dispense them through optional mechanical transfer mechanisms designed to secure the contents while they are being transported and to release them after a security code is entered all combined to operate and be moved about from one location to another through intelligent electronics, employing global positioning systems and or scanning techniques driven by mechanized and electromechanically driven or combustion driven engines, or other engines being devised, powered by fuels, fuel systems, gasses, or battery cells traversing about upon wheels, or treads or other traction means, to move about on pavement, factory floors, plants, or office environments, upon asphalt, upon concrete flooring, upon tile flooring, or to move in outdoor terrain, including land or sea, freshwater or saltwater, or even in battlefield conditions or in intelligence operations to automatically move items from one location to another and back again.

There are basically 8 variations of the automatic-transport system; these include: The consumer version where a garbage automatic-transport system is proposed in various models where the unit automatically opens the garage door by sending a wireless signal from the automatic-transport system's transmitter to open the garage door through the garage door opener at a programmed time or in manual mode as mentioned. The garbage automatic-transport system will then take the wagon or wagons attached together to the designated drop-off area programmed by the consumer and drop off the garbage cans, recycle bins, leaf paper bags, plastic bags, or anything placed on the platforms of the wagon(s), and drop-off all the non-empty containers and garbage. The automatic-transport system will then return back to the open garage and then close the garage door automatically, or it can be set for the consumer to close his or her garage door manually.

Also, there are (7) seven additional commercial variations of the automatic transport system; these include: a) The drum-style receiver auto-transport system, with mechanical transfer systems designed to release drums to designated areas b) The box, cargo-style receiver auto-transport system, including lumber and construction materials transport bundling, with mechanical transfer systems designed to release box and cargo items to designated areas c) The pallet-style receiver auto-transport system bin type, to release pallet(s) to designated area(s), d) The manufacturer cell to cell style auto-transport system, designed to move parts to be manufactured in step by step processes and e) a single person or multiple people mover f) a postal service carrier unit designed to carry mail, packages, and documents to secure mailboxes of residential, business, and industrial complexes, and g) automatic-transport systems designed for streets, highways, and public areas (some of these units are pictured in the drawings and others are explained in the embodiments and the objects and advantages and the components of this document). Not all variations of the automatic-transport system are shown and depicted in the drawings because they are considered obvious from the specification of the embodiments, the objects, and advantages, and the components specified herewith.

The automatic-transport system is comprised of a number of wagon-like components designed to transport people or objects and to dispense them at programmed location(s) through optional mechanical transfer mechanisms designed to secure the contents while they are being transported and to release them after a security code is entered all combined to operate and be moved about from one location to another through intelligent electronics, employing global positioning systems and or scanning techniques driven by mechanized and electromechanically driven or combustion driven engines, or other engines, powered by fuels, fuel systems, gasses, or battery cells traversing about upon wheels, or treads or other traction means, to move about on pavement, factory floors, plants, or office environments, upon asphalt, upon concrete flooring, upon tile flooring, or to move in outdoor terrain, including land or sea, freshwater or saltwater, or even in battlefield conditions or in intelligence operations to automatically move items from one location to another and back again as desired from one location to another as programmed, or in real time, from remote computer, or through navigation controls built-into the control panel of the automatic-transport system. Said automatic-transport system to have all features, logic circuits and components required for operation as described in the objects, advantages, and embodiments found and detailed in this document.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A machine having automatic transport capabilities with scanning and GPS functions comprising:
i) an electronically driven or a combustion driven automatic-transport system;
ii) means to travel from one location to another and drop off contents through electromechanical, hydraulic, and or pneumatic means;
iii) electromechanical motors or engines utilizing combustion means that the automatic transport system may move contents from one physical location to another;
iv) means to provide logic circuits with transmitting and receiving RF modulation circuits with an interface to control them, that will enable the automatic-transport system to arrive at a destination and alert a manager or employee or both or other people electronically, or a consumer in consumer models to take further action, or to automatically trigger the a manufacturing cell, or a destination it comes to unload the automated transport system utilizing electromechanical transfer system(s), and or to drop off contents automatically, and logic circuits with memory that will enable the automatic-transport system to remember its path and return back where the automatic transport system came from or to proceed to another destination either by travelling in reverse by following a line through scanning means, or by following GPS coordinates, and or by performing each operation in reverse, or to await for a remote RF modulation signal from a computer or from an employee to be sent back to where it came from or to proceed to another destination;
v) means to provide logic circuits and a manual interface, composed of knobs, buttons, dials, an LCD readout or other interface means to control the operation of the automatic-transport system aboard the automatic-transport system;
vi) means to provide an ignition or a startup procedure procedure that will power-up the automatic-transport system or start the automatic-transport system's engines and logic circuits;
vii) means to provide logic circuits and a mode of operation that will enable the automatic-transport system to remain in stand-by mode to receive commands via a RF modulation circuit that will activate the ignition of motors to start them up and to give the transport system commands for its destination(s), and or to lockdown when it reaches the destination(s) docking on a lockdown pin for secure docking;
viii) means to provide logic circuits with transmitting and receiving RF modulation circuits with an interface to control them, that will enable the automatic-transport system to arrive at a destination in commercial and or in consumer models to drop off a payload wagon, and or to optionally lock down the payload wagon on a lockdown pin upon delivery for secure delivery at a designated delivery point, said automatic transport system designed to drop off the payload wagon and lock the wagon automatically to a lockdown pin by docking to it, and logic circuits with memory that will enable the automatic-transport system to remember its path and return back where the automatic transport system came from or to proceed to another destination either by travelling in reverse by following a line through scanning means, or by following GPS coordinates, and or by performing each operation in reverse, or to await for a remote RF modulation signal from a computer or from an employee to be sent back to where it came from or to proceed to another destination; and or means whereby the automatic transport system can use operational memory that would record speed and steering signals and other operating parameters to drive the automatic transport system via macro(s) to go from one destination to another and to perform operation(s) as desired to deliver and or go to pick up items and return to a location or to proceed to another location.
ix) means to include the design of various models of a wagon-like automated-transport system having at least three (3) or (4) four wheels per platform area for the design of an automated transport system where (1) or two (2) wheels of the automated-transport system will be used for steering the automated-transport system attached to an electromechanical steering system controlled by a circuit designed to follow a line, no matter how it is drawn, in direction “X or Y”, forward or reverse, for length “Z” through scanners installed on the bottom and or the front/back, bottom, and or side(s) of the unit, and or by employing GPS coordinates and directions with or without the need for employing the use of lines and scanners for avoiding obstacles in the automatic transport system's path, and where the other two wheels will be used for stability and to make it mobile;
x) means to include an optional suspension system for wheel(s) of the automatic-transport system or for track(s) of the automatic-transport system (if treads are used in the design), for going over uneven terrain when the automatic-transport system if following GPS coordinates on its path, or for when the automatic-transport system is following a taped line or a painted line on pavement or on flooring or asphalt or on the ground, or even if the automatic transport system has to climb or go up and down steps, over steps, through ditches, or over bumps over a variety of speeds;
xi) means to include an optional paint-spraying mechanism on deluxe models of the automatic-transport system where the automatic-transport system can be programmed to draw a painted line or to dispense and glue a length of waterproof taped line used for scanning on the floor of garages or driveways, or on factory floors, or other environments with components where the automatic transport system can read the painted line(s) and or the taped line(s) through its barcode scanner(s) when it is in operation mode;
xii) means to include logic circuits that will allow people or contents to be moved from one location to a designated area by a user pressing a button on the automatic-transport system to send it in manual mode, or in automatic mode when the unit is filled to capacity a weight sensor will activate the unit to: a) alert users that the transport system is filled to capacity, and further to prompt users for further instructions, which may further: b) start the electromechanical or combustion motors that will move the wheels of the unit to follow the taped or pained line on the pavement or the painted line in the direction chosen (to designated area “X”, back to loading area “Y”, forward or reverse) as chosen in the programming of the automated-transport system to a designated area, for “Z” length away from the loading area, or by using GPS coordinates or scanning means on the automatic transport system to go to a location or to a series of location(s) either as stored in memory; downloaded through wireless or wired means; manually inputted; or received through wireless means in real time; or through other means;
xiii) means to provide a custom-designed electronic programmable digital assistant device or wireless remote to be built with logic circuits having built-in GPS programming functionality that will automatically record GPS coordinates over time as it is moved from one location to another once being activated recording and plotting the location where a user travels with it and where the programmable digital assistant or wireless remote device can download GPS coordinates to the automatic-transport system either through wireless means or through a computer port to allow the automatic programming of the automatic-transport system so a path can be automatically downloaded to the automatic-transport system and so the automatic-transport system can then move to follow those coordinates and travel through a manufacturing plant, manufacturing cells, quality control cells, testing cells, painting cells, process cells, packaging cells, warehousing, offices, mail routing, mail rooms, through military establishments, for field operations, for the military, the battlefield, for commercial applications, to deliver construction supplies, intelligence or other operations, to allow the delivery of a person, people, to move items or cargo placed on the platform(s) of the automatic-transport system just like the electronic programmable digital assistant device or wireless remote was walked through an area within a certain programmable settable deviation whereby the GPS device has an interface built-in that will allow a user to depress button(s) to specify a starting location and or a destination location and to include interface controls that will allow a user to direct the automatic-transport system to return back to its start location and or to proceed to other destination(s) as desired in a cylical fashion for repeated pick-up and drop-off operation(s) or to operate in single run operation(s) back to the start location or to other destination(s) whereby the PDA or the wireless remote is further comprised of a programmable digital assistant or a wireless remote designed to record GPS coordinates over time and save them for downloading to the automatic-transport system either through a wired connection or through wireless means whereas a programmable digital assistant or a wireless remote is designed to record GPS coordinates over time and save them for downloading to the automatic-transport system either through a wired connection or through wireless means comprised of a programmable digital assistant or a wireless remote RF transmitter having a transmitting and receiving antenna; a LCD readout for operational commands and for interfacing with the automatic-transport system; a record button or interface used to start recording and saving global positioning satellite coordinates over time as the PDA unit or wireless remote travels through an area; where the PDA or wireless remote is further comprised of interface buttons that allow a user to call up software and use a mechanical or a software-based alphanumeric keypad/keyboard on the LCD to communicate with the automatic-transport system; pushbutton control interface buttons or other control means that allow a user to enter identification and commands to communicate with the automatic-transport system to assign unique identification to automatic transport system units and to assign frequencies to transport units to allow multiple units to be controlled within the same environment with a programmable digital assistant, through a wireless remote, or through wireless means, through computer(s), or other methods; an ID program pushbutton or control interface that allows the user to enter into a program mode which allows a user to enter an ID for the automatic transport system; backward/forward buttons that allow the user to enter the next letter when entering the automatic-transport ID in program mode or to back up and correct a mistake; a save button that saves the automatic-transport ID number after it is entered in successfully; a start-automatic-transport-unit button designed to start the automatic-transport system; a send button that sends the saved GPS coordinates and the path(s) to the automatic-transport unit so that the transport unit can receive data or information to go to its destination(s); an interface that will allow a user to tell it to cycle and or repeat an operation a certain number or times or until sensor(s) detect that there is no more cargo to be loaded or unloaded at a destination; an interface that will allow a user to map the transport system to load or unload cargo in rows and columns with or without a space in between each cargo item of “X” distance in an orderly fashion in designated areas through assignable GPS coordinates or painted line coordinates that can be selected through the PDA or the wireless remote or through computer means; an interface that will allow a user to enter cargo data, lift information, destination data, and that will allow a staff person to manually map out destinations and activities that the transport system will perform; an interface that will allow a user to program the transport unit as to how to load or unload the transport unit, how to turn or rotate the cargo for loading or unloading, or how to overide built in scanning logic to overide normal loading and unloading functions that are built-into the system; what lift mechanisms to use for what cargo; what destination(s) to go to and where to return; what cargo items to select for pick up and or delivery; what deviations to accept or reject for all modes including: 1) if an obstacle is found how far should the transport system deviate from its path to try to get around it; 2) if a cargo item is to be delivered and there is no space for it to be placed in a designated area how far should the robotic transfer mechanisms or the transport system move to try to find a space for it to place the cargo in a free area before calling alerting a staff person, or then choosing to start to place the cargo item in alternative area(s) chosen in memory or returning to the send location as programmed with a message saying operation failed; further the GPS and or wireless remote allows the transport system to be commanded as to what mode to use and select such as: 1) painted path control, where the transport system follows a painted line or a taped line and automatically steers, with speed and direction and control and braking set through controls following paint sensitive sensors or scanners for a distance “X” to settings and utilize manual steering, manual acceleration, and manual braking whereas the automatic transport system may still have fully automatic steering, braking and acceleration functions with the capability to have manual operation as well; 3) programmed path: where global positioning satelite coordinates control steering, speed, and directions and where instructions are received to direct the transport unit on its path from a ROM in the transport system's logic circuits; 4) RF controlled path where steering, speed and direction control is controlled through wireless means either through a staff operator in a manual method in real time by operating a wireless remote or a PDA device or other instrument to control the transport unit or by operating a computer to control or direct the transport unit through RF means; an interface that will allow a user to enter further data or passwords, an on/off button to power-up the programmable digital assistant or the transport system; a cancel button to cancel an operation or a command; a scroll button to scroll through commands designed to operate and interface with the automatic-transport system; a USB or other computer port to download GPS coordinates to the automatic-transport system; a battery to power the PDA or the wireless remote; an AC/DC adapter as alternate power means for providing power to the PDA and or to recharge the unit and also whereas the PDA or the wireless remote system or other control system including the manual control panel on the transport system itself will have an interface and all the logic and circuitry to control and operate and provide means to enable all the control, features and interface functionality to control the automatic transport system to enable and control all features and model variations included in all the claims and the items described in the specification;
xiv) means to include logic circuits to provide programmability where the automatic-transport system can be programmed to recognize when it is in a “Loading Zone” and logic means that will enable it to travel a certain distance “Z” from a “Loading Zone” to go to a “Destination Zone”, then proceed to return to the “Loading Zone” or to proceed further to another “Zone” by following a line that is either painted on the floor or taped on the floor;
xv) means to include logic circuits and scanning means with intelligence that will enable the automatic-transport system to follow painted or taped lines on the floor of a factory, or elsewhere, with the intelligence that will enable the automatic-transport system to choose from a multiplicity of path(s) as according to its directions when coming to a node where there are multiple lines where the automatic-transport system can be directed to make a decision to choose any one of the lines it comes to to follow a route to a particular destination;
xvi) means to allow an automatic-transport system to be constructed that will allow at least one platform cargo area to be moved from one location to another, said platform area constructed in a fashion to allow the receipt of items to be placed upon the automatic-transport system, and or said platform area may be designed in different configurations to allow seating or standing for one or more people to step, stand, and or sit on the platform and be moved from one location to another, including variation(s) where the automatic-transport system can have multiple floors depending on how large the automated transport system platform(s) are made and how sturdy it is made to accommodate the weight of items that will be placed upon the platform area, and whereby models where the platform will be utilized for the loading and unloading of pallets the automatic-transport system will have electromechanical, hydraulic or pneumatic means to load and or drop off the pallets when commanded to do so when the automatic transport system reaches its designated loading or unloading area and whereas the automatic-transport system can go into a “hold” mode when it reaches its designated destination and alert the manager, an employee, or other people that it has arrived through wireless communications to a computer via email, or other visual or audible means, and or it can just drop off contents and return back to the loading area automatically, or wait to be sent back by user interaction after entering a security code or to proceed to another destination or area;
xvii) means to allow the automatic-transport system to be used for moving waste, or garbage cans, scrap or recyclable materials, contaminated waste, radioactive materials, chemicals, bio-hazardous waste or other materials, boxes or canisters, or drums, or where items are valuable, whereby special electromechanical holding arms or lockable covers can be utilized that will lock the items securely in the automatic-transport system while it is moving and whereby they will release the items from the automatic-transport system only upon a security code being triggered and whereby prior to such entering of a security code no release of the items can be made and when the security code is entered a further functionality of the system allows a wired or a wireless connection to interface with a company's software and or computer system to update warehousing records that items are received and now in stock in the warehouse, while keeping the transported items locked in place within the automatic-transport system until they get to their destination for added security while the automatic-transport system is moving and whereby the security code can be entered automatically by the system once it has traveled to its destination after traveling “X” or “Y” distance, forward or reverse, travelling a distance of length “Z” as it was programmed to do so from its starting point, and whereby the automatic transport unit will unlock its contents after a user, an employee or manager with authority enters a security code either through a manual interface upon the automatic-transport system or through wired or wireless means via a manual interface aboard the automatic transport unit, a PDA link, a computer link, or through a remote control device;
xviii) means to allow the creation of different automatic-transport systems to be made that can scan and follow lines drawn or painted on pavement or asphalt or read tape glued on pavement or asphalt and travel from a start position to an end destination to deliver items or people from one location to another, and or by employing GPS, (global positioning system technology coordinates and trail navigation techniques where one can draw a path precisely how they would like to travel utilizing GPS coordinates mapping);
means to programmably enter and change the speed of the automatic-transport system that can vary at any point in time at which the automatic transport system will travel to destination point(s) through a manual interface upon the automatic-transport system or through a RF modulation circuit controlling the automatic-transport system at any point in time said automatic-transport system also having an optional accelerator on the floor, and an optional steering wheel that can override GPS signal(s), or the scanning of taped-painted lines on a floor, to be used by an operator to vary the speed of the system and to steer the automatic-transport system as one would use as in driving a car in alternate models of the present invention whereby the automatic-transport system could be used in moving people or items by allowing for the construction of models that have an optional cab with optional steering, optional acceleration and optional braking as well as fully automatic models where a driver is not needed where automatic transport systems steer themselves and accelerate and brake automatically with intelligent obstacle avoidance sensor technology and logic for all operations, scanners and sensors required where it should be understood that in fully automated transport system models there is no need of manual acceleration, or manual braking, or manual steering because the automated transport system has automated steering mechanisms, automated acceleration and automated braking and shutdown including fully automated pick up and unloading capabilities;
xix) means to provide an automatic-transport system with an array of sensors and logic circuits that will keep the automatic-transport system centered on top of the painted line or the taped line within a pre-programmed settable deviation to the line and to follow it while the automatic-transport system is moving to its destination(s), and a forward and a reverse looking scanning array of scanning sensors so that scanners can read the lines and always center themselves in towards the middle of the taped or painted line so as not to go off-course while the automatic-transport system is moving towards its destination(s) to keep itself centered on top of the line while the automatic-transport unit is traveling within a certain deviation of “x” length from the line(s) the automatic-transport unit is following;
xx) means to provide logic circuits with the functionality to allow the automatic-transport system to make a choice at each destination or at each stop to select from a series of directions it can go to from each stop it makes either through GPS coordinates stored in memory for the next location it will travel to or by following a certain painted or taped line on the floor through scanner means that it is programmed for, and or by performing operations stored in memory and whereby GPS coordinates or choices can be changed on the fly manually by an interface on the built-in automatic-transport system's control unit or through wireless means through a computer remotely and whereby the automatic-transport system can be programmed to drop people off going through “X” number of nodes or destination(s) and whereby it can be programmed to return to any destination or to proceed to another destination through line scanning means or through GPS coordinate traveling means, or through operational command means that will command the system to travel a certain distance in a given direction and turn as desired not utilizing GPS, or line scanning means;
xxi) means for the automatic-transport system to incrementally control steering in any direction with servo motors in a given direction as controlled by operational commmand means over time at a certain programmable acceleration speed that can be changed at any time with scanning means and go-around intelligence, or wait-intelligence for the path to clear, to avoid obstacles;
xxii) means for the automatic-transport system to provide an audible alert or warning as it is moving to warn employees or the public that it is coming through an area;
xxiii) means for the automatic-transport system to provide a platform with support for moving people or objects from one location to another with optional support structure(s) to accommodate the securing of objects to be placed into or unto the automatic-transport system's platforms or further support structures for people to support themselves while traveling on the platforms such as something to hold onto such as a rail, especially when boarding or when the platform is moving, or something to sit on, such as seats, benches, and the like, for extra comfort;
xxiv) means for the automatic-transport system to operate with a wired or wireless communication port that will allow the automatic-transport system to interface to computers through a software interface that will allow accounting records to be updated to provide a date and time and to state specifically what cargo has arrived; also to provide a date/time stamp of where cargo or people are on the transport system at any time to report status continually; and also to send an email to managers and or to employees and or other(s) alerting them to them to the fact of the time and date and or as to who or what cargo has arrived when it has arrived at a particular programmed destination; and or whereby said software or logic will update records when cargo or people have arrived at a certain destination or node in a plant or warehouse or other area as such deliveries occur in an automated fashion;
xxv) means to allow an automatic-transport device to be developed for home use for the consumer user or for commercial applications that will allow the consumer or the commercial user to keep the automatic-transport system outdoors, or in their garage, or in a secure area at a starting location that as in many suburban settings an automatic-transport system can be utilized to automatically deliver garbage, yard waste and recyclable items to the front of a person's driveway, or from their back door or from inside their garage or in a secure area to their alley, so that waste haulers can take the garbage away automatically, said consumer version or commercial version having at least one platform area to load and or unload garbage can(s) upon it with optional electromechanical, hydraulic, pneumatic and or robotic transfer mechanisms to load or unload the garbage can(s) at a destination point, also having alternate version(s) that can deliver and dock a payload wagon at a lockable pin cemented in the ground locking a payload wagon containing garbage can(s) to the docking pin and then allowing the automatic-transport system to return to the garage or the starting storage location outside the home or in a secure area to be activated later to go back to the garbage drop-off area to be loaded again with the empty garbage cans after waste handlers have emptied the garbage; or to pick up the dockable wagon; said consumer version to be used in commercial environments and to be modified to accommodate commercial garbage cans and or bins as well;
xxvi) means to allow the development of an automatic-transport device that will have a series of platforms in a consumer version or a commercial version that will allow consumers to place at least one garbage can on each platform unit, each platform unit having a weight sensor to determine if the garbage can is empty whereby users can fill garbage cans in a sequential fashion and whereby the automatic-transport unit can be programmed to take and drop off only the platforms to the garbage destination location when delivering garbage when it senses that the cans have garbage in them by analyzing their weight;
xxvii) means to include logic circuits that allow consumer(s) or commercial user(s) to program the day(s) of the week and the time he or she wants the unit to put the garbage out whereby the automatic-transport system has an internal clock that keeps track of the time(s) and day(s) of the week whereby the automatic-transport system also has logic circuits that enable it to use a radio transmitter that will trigger the garage door opener and open an electronic garage door or an electromechanical door or gate or other secure closure system automatically, with a time delay to wait until the garage door opens completely before the automatic transport system travels out to the front of the driveway or to the alley or in a warehouse so the automatic-transport system can travel outside of the garage or to the designated drop-off area and or to receive input from a garage door or electromechanical door or gate sensor to tell the automatic transport system when the electronic garage door or other door or gate has fully opened that the transport system may move unattended following the line or the tape glued to the pavement or the asphalt driveway to drop off garbage and then return to the garage or to the secure area after dropping off the garbage and go back to its original location lock itself down to a locking pin by docking to it and then sending a signal to close the electronic garage door whereby upon returning if it finds the door closed through its obstacle avoidance sensor(s) it can stop as necessary and send a RF transmission signal to open the electronic door and wait a time “X” which can be programmed into memory for the gate or door to open and check the obstacle avoidance sensor again to see if the path is clear and then proceed to go back and dock to its original location and lock itself down to a locking pin by docking to it and then close the electronic door and shut itself down and go into stand by mode or shut completely off as programmed;
xxviii) means to include logic circuits that will allow an automatic-transport system to be developed that will allow it to capture the an electronic garage door opener's frequency or an electric door's frequency and store the same for later use to open and close the electronic door opener when the automatic-transport unit is activated to go out and deliver the garbage or cargo to the destination location;
xxix) means to include logic circuits that allow the automatic-transport system to see ahead through scanning or sensor means whether travelling forward or in reverse and or if the unit comes into an area where it comes into contact with an obstacle and it cannot proceed to continue to its destination and cannot go around said obstacle to get to its destination through alternate routes, the automatic-transport unit will have the intelligence to trace back its steps and return to its previous location and report a pre-programmed condition message such as: “Delivery Not Made, Obstacle In Path, Transport Unit Returned To Previous Send Location” on its LCD readout on the transport unit and to report the same in email(s) as to when such event occurred to selected individual(s) through transmitting RF modulation circuits through wireless means, and or through wired means;
xxx) means to include logic circuits in the automatic-transport system with the use of weight sensors that can sense which of the platforms in the chain of platforms in the automatic-transport system are empty whereby when the automatic-transport system reaches its destination, if the garbage can is empty it is not ejected, but rather it is taken back to the garage, or to the original loading area and whereby it is proposed that consumers use and fill the first can first, the second can second, the third can third, and so on when filling them in order for proper operation that the automatic-transport whereby the system may sense which cans have garbage in them by analyzing their weight and then drop off garbage cans one next to another when reaching its destination so that it would make things easier for waste haulers, and so things will look neater at the end of the driveway or in the alley, or in a destination area;
xxxi) means to provide an automatic-transport system in various models where one automatic-transport system can have multiple platforms built into it with weight sensors, platforms being of “X” length, and “Y” width, and also in alternative versions where a chain of platforms can be connected together so that a consumer or a commercial user can add or subtract as many platforms as he or she may require per run depending on how many garbage cans or pallets or platforms he or she wants to move at a time whereby there may be models devised where a chain of platforms are used whereby the automatic-transport system will have the intelligence to sense how many platforms are connected together, and it will release only the items above a certain weight if programmed to do so, or all the items, as desired upon reaching its destination as previously mentioned, and the release mechanisms will work on every platform as programmed, no matter how many or how few platforms are connected together and whereby the automatic-transport system will work to release all items chained together, every item above a certain weight, or every item brought to the destination on every platform and whereby the automatic-transport system can be used to move objects in manufacturing lines from one operation cell to another and the wheels of the automatic-transport system can be modified to be installed on a track, or to be installed in a geared track, or the automatic-transport system can travel from one location to another on the manufacturing floor with rubber tires, or with rubber tracks, or other traction means;
xxxii) means to include logic circuits and functionality and controls in an automatic-transport device to deliver recyclable disposal bins, garbage cans, disposal containers, plastic bags, paper leaf bags, etc., from a loading area to a designated area such as the end of a driveway or to an alley for pick-up by waste haulers triggered for movement after a user manually triggers the automatic-transport system to deliver the garbage for waste removal to the programmed area, and return the automatic-transport system back to its loading area, where the automatic-transport system has the option to either send a remote transmission to open the garage door, or where the user can set the automatic-transport system to be in total manual mode where the user sets the system to make sure he or she opens the garage door and then he or she manually triggers the automatic-transport system to send the garbage out to travel to a destination area and whereas in manual mode the automatic-transport system can be optionally set to always return to the designated loading area after dropping off the “recyclable disposal bins, garbage cans, disposal containers, plastic bags, paper leaf bags, etc.” at the programmed drop-off site having a distance of “x” length from the loading area;
xxxiii) means to include logic circuits for all of the functions mentioned in the objects of the present invention;
xxxiv) means to provide power to drive the automatic-transport system either through a battery strong enough to drive the electronic motors that will drive the motors and the electronics of the automatic-transport system for the weight load(s) the automatic-transport system will be carrying, or combustion engines powerful enough to move the loads they will be carrying;
xxxv) means to provide an automatic-transport system with scanning ability to not only be able to scan lines taped or painted on pavement or asphalt or roads, but to be able to scan bar codes or other symbols that can relate information to the automatic-transport system so that the automatic-transport system will know where it is and display that information on a display panel as programmed, and or so that information may be transmitted through the wireless communication port to a remote computer to tell a computer where the automatic-transport system is so that cargo, or people can be monitored to have arrived at a particular destination and whereas in the GPS models, the automatic-transport system can always tell the display on the automatic transport system map where it is at any point in time, or GPS coordinates can be fed to a remote computer at all times to track where an automatic-transport system is at all times;
xxxvi) means to provide an automatic-transport system further comprised of main components and subcomponents including but not limited to: electromechanical motors, servo motors, other motors, and or combustion motors used to move people or objects placed on the platforms of the automatic-transport system; forward looking scanners used to read lines drawn on pavement or flooring so that the automatic-transport system can follow a painted line or a taped line course to destination(s), and to read bar codes to report where the automatic-transport system is at any point in time; sensor(s) used to detect obstacles in the automatic-transport unit's path; a global positioning coordinate system device that will enable a user to download path data to the automatic-transport system so that the automatic transport system can travel to programmed destination(s); a steering control system that will be used to steer the automatic-transport system to follow. GPS coordinates as downloaded to the automatic-transport system or to follow taped or painted lines on the pavement or factory or warehouse or office floors through scanning means; the circuit card(s) employed by the automatic-transport system contain all the logic circuits that have the functionalities contained in the objects of the present invention; a wireless communication port with with RF modulation transmission and receiving circuitry that allows the automatic-transport system to communicate with remote computers to update accounting records, to send emails to employees, managers, and other people as to the arrival of people, cargo, or items to a designated area through built-in logic and or software, and functionality to receive commands that will control where the automatic-transport system goes for unattended automatic operation via computer control; said automatic transport system with a built-in user interface allowing a user to manually control the automatic-transport system having data-entry means and or control means and display means to control system go to a certain location by entering a security code as pre-programmed or to change it on the fly;
xxxvii) means providing electromechanical, pneumatic, or hydraulic release mechanisms used to hold and lock down cargo or items while they are in transport for security reasons said mechanisms made to release said items upon a security code being entered either automatically when reaching a destination or upon a user or a computer entering a valid security code; whereas the automatic-transport system has optional support structures built-into the automatic-transport system to accommodate cargo so cargo or items can be supported better or handled more efficiently or to make their handling more secure; whereas in the case of moving people, support structures can include a holding bar where a person or people can hold on to a rail when the platform is moving, or other support structures such as seating can be provided; and the locking system consists of a locking pin on the automatic-transport system that mates with and locks with a pin that is cemented in the ground or in the floor of a factory or a garage or a particular destination where the automatic-transport system locks down at when programmed to or when completing a run after making a delivery and returning to a loading area so the automatic-transport system cannot be stolen;
xxxviii) means to load and unload contents into and out of the automatic-transport system through one or more mechanisms designed to load or unload content(s) into and or out of the automatic-transport system comprised of electromechanical, pneumatic, and or hydraulic transfer systems with and or without grasping mechanisms to take hold of and or grab onto garbage cans, boxes or other items that are to be loaded or unloaded into or out of the automatic-transport system; and or an automatic-transport system further comprised of ejecting arms that will push off slidable pallet(s), drums, bins, bags, boxes or other objects off of the automatic-transport system onto the ground or floor; and or an automatic-transport system further comprised of optional dockable and releasable platform areas that can be locked into place or unlocked and used to place items upon them that can be released, ejected and docked into or out of the automatic-transport system and that can be used to place contents upon them where said platform areas can also be wheeled-pallet(s) that can be placed into or out of the automatic-transport system that can lock in place and dock with the automatic-transport system and released at a designated drop off point whereby once it is dropped off said wheeled pallets are further comprised of lockable wheel systems so as to lock in place to prevent further movement once dropped-off the platform areas from within the automatic-transport system unto a designated delivery point upon disengagement from the automatic-transport system;
xxxix) means to provide an automatic-transport system that will upon receiving an authorized signal allow the loading or release of lockable-and-unlockable-dockable-wheeled-platform areas into or out of the automatic-transport system from any side of the automatic transport system including in front of the automatic-transport system, behind the automatic-transport system, or on the left or the right of the automatic-transport system through electromechanical, pneumatic and or hydraulic means at a designated drop-off or loading point authorized and verified by GPS coordinates or at designated coordinates from following taped or painted line paths;
xl) means to provide an automatic-transport system that will create an authorized signal to drive circuits that will eject and or load items out of or into platform areas of the automatic-transport system from any side of the automatic transport system including in front of the system, behind the system, on the left or the right of the system through electromechanical, pneumatic and or hydraulic means at a designated drop-off or loading point authorized and verified by GPS coordinates or at designated coordinates from following taped or painted line paths;
xli) means providing an automatic-transport system with a logic control system and memory systems with a manual and or a wireless interface system that will allow the automatic-transport system to remember the exact GPS pick up or drop-off point(s) or to memorize the distance from the starting location to the drop off point(s) by following painted or taped lines by scanning means to allow an object to be ejected or dropped off from the automatic-transport system in a cyclic fashion through a subtractive indexing method whereby the automatic transport system: 1) scans the size of the package it is delivering or picking up, 2) stores the size of the cargo in its memory, 3) picks up or drops off cargo at a programmed location, 4) has the option to return to drop-off or pick up more cargo or pallets as in from a truck de-loading zone, 5) the automatic-transport system drops-off or grabs another pallet or cargo unit and it returns to the same pick up or drop-off zone by following the same GPS coordinates or a scanned line to return to the same previous drop-off location but it stops and drops off the cargo through automatic transfer mechanisms just short the distance of the first run determined by the size stored in the memory of the package or cargo delivered on the previous run and it can optionally add a space of “X” length between each cargo placement that it delivers or picks up, and whereby logic is present whereby scanners aboard the transport system scan the area where the transport system will make a delivery to see if there is a space available that will accommodate the pick up or delivery of the cargo and will position the cargo and the transport system to attempt to place the cargo in a space within a certain acceptable programmed deviation whereby if a space is not available the unit will prompt staff for further instructions or proceed for the next instruction such as proceed to the next row and start to deliver and place cargo in new rows as programmed and whereby these operations can keep cycling to deliver cargo pallet after pallet, drum after drum, box after box, etc; right next to each other with or without spaces between them as set by the variable “X” from one location to another automatically through electromechanical, hydraulic, or pneumatic, transfer mechanisms and whereby the logic control systems on the automatic-transport system also have the capability to control the automatic-transport system through manual or wireless means to direct where the automatic-transport system goes through GPS coordinates, or by following scanned lines drawn on pavement and logic to direct the automatic transport system for how the pallets are dropped off in formation whether in a line next to each other, or in rows, and also to specify how many in each row, and where the commands can be programmed by staff or managers with passwords;
xlii) means to provide an automatic-transport system with platform loading and unloading section(s) having roller mechanisms and securing mechanisms to allow loading and unloading and securing of cargo unto and off of the automatic-transport system(s) into at least one designated bay built into the automatic-transport system with logic control circuitry that a user can select the parameters of operation through the control panel on the automatic-transport system's interface or where the parameters can be changed through wireless means that will allow the automatic-transport system to receive cargo in one or more platform bays in a sequential or in a custom selectively programmed order to fill said bays to fill or unload from “left”, “right”, “front”, and or “rear” platform bays as desired utilizing electromechanical, pneumatic, and or hydraulic transfer mechanisms with the understanding that various automatic-transport systems may be constructed where there may be one platform bay where cargo may be loaded or unloaded or where there may be other automatic-transport systems developed with a plurality of platform bays for loading and unloading cargo unto and off of the automatic-transport systems;
xliii) means to provide the logic necessary to control the configuration of the loading/unloading and securing/releasing operations of the automatic-transport system entail the prompting and utilization of electromechanical, pneumatic, and or hydraulic transfer mechanisms that grasp cargo and pull it unto platform areas sliding it across rollers unto the automatic transport system into platform areas in designated programmably selected holding areas filling each platform bay in a selectively programmed fashion or sequentially bringing each pallet, box, drum, or other item to rest whereby when cargo is loaded a series of primary and secondary barriers arise securing each cargo item or groups of cargo item(s) on each platform bay whereby such barriers are raised after cargo is placed on platform bay(s) after arriving at a loading zone whereby the logic engages a securing phase where first a primary barrier rises to secure one side of cargo item(s) then a secondary barrier rises up from the floor, a certain distance “X” from the floor to prevent the cargo for sliding back and forth upon rollers on the platform bay's floor of the automatic-transport system's floor and a certain distance “Y” from within the automatic-transport systems floor plan to rest against the cargo after scanning the cargo whereby the automatic-transport system's scanner scans the size of the cargo and loads the size of the package into its memory, either through optical sizing, by reading a barcode, or by receiving data of the cargo through wireless means, or by a user entering data into the automatic transport system manually, to determine the cargo's size to position and select the appropriate secondary barrier” and position it to secure cargo through electromechanical, pneumatic, and or hydraulic means to keep and hold cargo in place holding the cargo between the wall of the primary barrier and between the “secondary barrier” and whereby further logic is included to provide unloading functions whereby the “secondary and primary barrier(s)” are lowered and then the electromechanical, pneumatic, and or hydraulic transfer mechanisms can then grasp the cargo and move the cargo out of the automatic-transport system to unload the automatic-transport system once the automatic-transport system has arrived at a drop-off or an unloading zone and is prompted to begin unloading operations either through manual or through wireless means or through pre-programmed instructions or through cycled operations for continual loading and unloading operations or for single run loading and unloading operations;
xliv) means to provide logic controls in an automatic-transport system with an odometer to measure the distance the automatic-transport system travels to correct for GPS coordinates and for when it travels following scanned lines which would be especially useful for cyclic operations that allow users to program only one destination as a destination whereby the automatic-transport system's scanner scans the size of the cargo and loads the size of the package into its memory, either through optical sizing, by reading a barcode, or by receiving data of the cargo through wireless means, or by a user entering data into the automatic transport system manually to allow the automatic-transport system to begin at a loading zone, load contents onto the automatic-transport system, scan the cargo system for its size, or otherwise receive cargo size parameters as stated, go to an unloading zone drop-off the contents through electromechanical, pneumatic, and or hydraulic transfer mechanisms, retain the size of the cargo it dropped off in its memory along with the distance it traveled from the odometer, return to the loading zone to pick up more cargo, reload, travel to the previous unloading zone from the previous odometer memory information, whereby the automatic-transport system can have the logic built-into the system where through manual, or wireless means the automatic transport system can be programmed in single run or in cyclic loading and unloading operations to stop short of its previous drop-off or unloading zone the distance or size of the cargo that it held in its memory from the previous run and or also a distance “X” which can be used for a space to be between the packages or the pallets being dropped off whereby this can be used for drop-off indexing;
xlv) means to provide the logic and the functionality for the automatic-transport system to automatically advance to cargo items in a designated pick-up zone align itself with the cargo, utilize scanners to see if the cargo is aligned with the transfer mechanisms for pick up and pick things up through its electromechanical, pneumatic, and or hydraulic robotic transfer mechanisms and load them unto designated platform areas by 1) scanning ahead in the direction of the pick up zone to determine if there is cargo to be picked up, 2) choose a lift device or transfer mechanism, then situate and position the robotic electromechanical, pneumatic, and or hydraulic transfer mechanisms left or right, above or below, in a position around the cargo and or underneath the cargo to lift, grab, and or move the cargo unto the automatic-transport system's platform bay(s), secure the cargo by raising the primary and secondary barriers after loading or if unloading lower said barrier(s), 3) proceed to the next cargo unit, drum, box, pallet, or other item if the automatic-transport system has multiple platform bays to fill and repeat the process to fill its bays, record loading information into memory and report status as programmed 4) proceed optionally to a drop-off zone after filling its platform bays and or then release its contents through the electromechanical, pneumatic and or hydraulic transfer mechanisms upon receiving a secure signal or a code to release contents if in secure mode;
xlvi) means to provide an automatic transport system in at least 5 configurations: 1) a tranport system designed with one or more electromechanical, pneumatic, and or hydraulic robotic transfer mechanism(s) aboard the automatic transport system that can load and or unload cargo into and or out of the automatic tranport system in an automated fashion designed for specific types of cargo such as pallets, drums, boxes, etc; 2) a transport system with electromechanical, pneumatic, and or hydraulic robotic transfer systems that can be fitted and exchanged manually by staff or users to load or unload different types of cargo such as pallets, drums, boxes, etc; 3) a transport system with electromechanical, pneumatic, and or hydraulic robotic transfer systems designed in a carousel, turret or other type of exchange system built into the transport system whereby logic and mechanisms aboard the transport system will allow the transport system to select a specific robotic transfer mechanism to grasp a cargo item after scanning the cargo as needed; 4) a transport system where the transport system can follow GPS coordinates or taped line coordinates through scanning means to a destination where it can then exchange electromechanical, pneumatic, and or hydraulic robotic transfer mechanism from a designated area either from a carousel exchange system or from another type of system or deployment method and where models have transfer mechanisms built into the transport system further functionality is included whereby there is logic and mechanisms to reset and park the electromechanical, pneumatic, and or hydraulic transfer mechanism(s) that they may return securely and be tucked away from the rest of the cargo to a dedicated platform bay area after loading or unloading functions or that they may remove themselves from interfering with cargo areas or other transport functions by moving to a designated area upon the transport system reserved for parking the transfer mechanism(s) after loading and unloading functions have been performed;
xlvii) means to provide an automatic transport system with the logic and circuitry and sensors or scanners for obstacle avoidance whereby object avoidance can be utilized in many ways to determine if there is an object in the automatic transport system's path whereby logic can be included to direct the transport system to proceed around an obstacle or to direct the transport system to return to the sending location and report a message to staff on the panel of the transport system or through wireless means to the staff that an obstacle was found in the path and that the transport system returned to send location without completing task(s) whereby a further feature of the obstacle avoidance logic in the transport system can determine where the transport system has to go to park itself in a secure area such as where the transport system would park itself normally and close a garage door or other electromechanical door, gate or other closure mechanism whereby the transport system logic would have the intelligence to know where the coordinates of this location would be through painted lines that it follows, or through GPS coordinates in memory and when approaching said coordinates after loading or unloading operations to park in said location it uses obstacle avoidance sensor(s) to determine whether or not said door is closed and if said door is closed when returning to store and park itself the transport system will use internal logic to automatically momentarily stop and engage RF transmission circuits to open the lockable electronic garage door or other electromechanical door(s), gates, or closure systems and then proceed into the garage or storage location, park in its designated spot, dock and lock unto its locking pin so it cannot be moved, send another RF signal to close the garage door or other electromechanical door, gate or other lockable closure system to seal off the storage area, and then shut down the unit or put itself in standy mode;
xlviii) means to provide an automatic transport system with the logic and circuitry to open electromechanical doors such as electronic garage doors or other electromechanical doors, gates or closure systems through “Garage Door Logic” that opens or closes a garage door or other door as needed which is not limited to garage doors, where said door can be any electromechanical door system or any type of closure system where the transport system can be stored and automatically released through logic controls where said programmable logic is utilized to open a garage door or an electromechanical door or other closure system where the transport system may be stored in a storage area upon the automatic transport system being activated for use to allow the transport system to proceed to a destination after a sufficient time delay to allow for the door to open and or to mobilize the automatic transport system to proceed to a destination for loading or unloading operations after receiving optional input from a garage door sensor input which tells the automatic transport system that the path is clear so that the transport system may proceed to its destination whereupon when the automatic transport system completes its journey it may then optionally return to the garage or storage area to its original area and it may send a RF signal and close the electronic garage door, the electromechanical door, other closure system, or gate to secure the transport in its storage area by having the garage door logic open or close the garage door as needed through the built in RF wireless RF transmitter which functions as a garage or door opener or RF transmitter output where it should be noted that object avoidance can be utilized in many ways to determine if there is an object in the automatic transport system's path whereby logic can be included to direct the transport system to proceed around an obstacle or to direct the transport system to return to the sending location and report a message to staff on the panel of the transport system or through wireless means to the staff that an obstacle was found in the path and that the transport system returned to send location without completing task(s) where through obstacle avoidance and logic in the transport system it can determine where the transport system has to go to park itself in a secure area such as where it would park itself normally and close a garage door or other electromechanical door, gate or other closure mechanism having the intelligence to know where the coordinates of this location is through painted lines that it follows, or through GPS coordinates in memory and when approaching said coordinates after loading or unloading operations to park in said location it uses obstacle avoidance sensor(s) to determine whether or not said door is closed and if said door is closed when returning to store and park itself the transport system will use internal logic to automatically momentarily stop and engage RF transmission circuits to open the lockable electronic garage door or other electromechanical door(s), gates, or closure systems and then proceed into the garage or storage location, park in its designated spot, dock and lock unto its locking pin so it cannot be moved, send another RF signal to close the garage door or other electromechanical door, gate or other lockable closure system to seal off the storage area, and then shut down the unit or put itself in standy mode;
xlix) means to provide an automatic transport system with optional electromechanical, pneumatic, and or hydraulic robotic transfer mechanisms for loading and unloading of cargo that have the functionality to turn and rotate cargo 0-360 degrees in a programmable fashion to load them and to turn the cargo for loading them unto the transport system or to turn and rotate cargo 0-360 degrees when delivering them when placing them or lowering them unto a designated delivery location with stabilizing means to prevent the transport system from tilting when picking up a load whereby the stabilizing means move downward towards the floor or ground as the load is lifted to bear the weight of the cargo as the cargo is turned or rotated 0-360 degrees to position it to place it and to move it unto the transport system stabilizing the load moving with it as the transfer mechanism(s) move to load the cargo unto the transport system;
I) means to provide an automatic transport system with logic, circuitry and mechanisms and directions to deliver or to pick up items from any location reachable by the transport system and or its extendable electromechanical, pneumatic, hydraulic and or robotic transfer mechanisms to include loading, pick-up, and or unloading applications from shelves, from trucks, from railroad cars, from one area to another, from manufacturing cells, for delivering garbage, scrap, materials or supplies, for delivering mail, for delivering people, or for custom applications where the transfer mechanisms can turn cargo items 0-360 degrees to place cargo in any rotational direction upon the platform bay(s) of the transport system or where the transfer mechanism(s) may place each cargo item 0-360 degrees in any rotational direction off of the transport system when making a delivery and whereby when the transfer mechanisms release a cargo item after placing each cargo item in a platform bay they disengage from the cargo item in a manner to release it to either proceed to park themselves and come to rest by securing themselves in a designated platform bay reserved for storing the transfer mechanism or they withdraw in an area reserved to store the transfer mechanism securely so as they will not interfere with further operations of the transport system or they will continue with further loading operations until they are done and then park themselves whereby if a transfer mechanism is engaged in loading or unloading items unto or off of shelves special logic can drive transfer mechanism(s) to move a certain length, width, height or depth within each shelf at a destination and whereby scanners can scan and determine what shelf they are at by counting how high on the “Z” axis or “height” they are raised or by optically detecting each shelf as they pass by it through scanning means via a counter that is set to detect shelves as the scanner head is raised on the robotic arm of the transfer mechanism;
Ii) means to provide an automatic transport system with and or without electromechanical, pneumatic, hydraulic and or robotic transfer mechanisms for the delivery of cargo to singular or multiple destination(s) and means to provide for the delivery of cargo to singular or multiple destination(s) with manual and or automatic secure lockable closure means such as electromechanical covers, doors, tie down straps, chains, cables, and or other manual or automatic systems, mechanisms or means that can be used to secure cargo while they are in transport for secure delivery of cargo which can be released through a password entered at the command console of the transport system or entered through wireless RF means, a wireless remote, a password, or through a GPS system or a special interface;
lii) means to allow an automatic transport system and or multiple automatic transport systems to be used and controlled by one or more users in the same facility and controlled by a GPS system or through wireless means and or through computers through a wireless remote or other control system where the automatic transport systems each have their own unique frequency or ID so that they can be independently controlled and programmed and operated to perform their functions;
liii) means to allow an automatic transport system vehicle to be developed with optional electromechanical, pneumatic, hydraulic and or robotic transfer mechanism(s) for the loading or unloading of cargo at destination(s) to operate in some models as a fully automated and programmable unit much like a robotic fork lift but with interchangeable robotic transfer mechanisms that can be exchanged to handle different types of cargo to operate in different selectable modes including following: 1) a painted path control where the unit steers itself to follow a painted path or a taped line utilizing paint sensitive sensors or scanners; 2) a manual path control where a driver can overide the automatic driving features of the system by utilizing a manual steering system, a manual braking and a manual acceleration system instead of the fully automatic features provided by GPS control, or by painted Path Control, or by RF control; 3) Programmed Path: where GPS coordinates control steering, direction, braking and acceleration are directed from instruction(s) loaded from a ROM; 4) RF controlled path: where steering, speed and direction and control is determined through wireless means in real time;
liv) means to provide an automatic transport system with the logic and circuitry and memory functions, date and time circuits input and output circuits for path programs, path recording, barcode information, remote instructions, cargo data, delivery status, updates, RF, manual signals, and memory allocations to include memory locations that include but are not limited to: a) DATE & TIME INFORMATION, b) GPS COORDINATES FOR WAREHOUSE & PATHS, OR MAPPED AREA, c) SPECIAL INSTRUCTIONS, d) INDIVIDUAL CARGO DATA, e) BARCODE INFORMATION & DECODING ROM, f) EPROM WITH PATH PROGRAMS AND GARAGE DOOR LOCATIONS, g) MULTIPLE PACKAGE DELIVERY CODES, h) WAREHOUSE CARGO DATA, i) SECURITY CODES & DECODING ROM, j) PATH RECORDING DATA, k) DELIVERY STATUS & UPDATES, I) USER SPACE WITH SPECIAL PROGRAMS, m) INSTRUCTIONS FOR LIFT LOGIC INCLUDING INSTRUCTIONS FOR LOCK DOWN MECHANISMS, n) ADDITIONAL INSTRUCTIONS, ETC;

2. A machine having automatic transport capabilities with painted path control, line scanning; programmed path control, GPS-ROM scanning; manual path control, operator control; RF control and GPS functions as claimed in claim 1 further comprising:
i) means to provide logic, circuitry, memory circuits within the automatic transport system, within the remote control unit and or within the programmable digital assistant including interface means to allow one to program the automatic-transport system to perform operational functions described within the scope of the present invention such as loading and unloading specific items into and out of the automatic transport system, and or to allow the automatic-transport system to dock and lock down on a pin cemented on the ground or to dock elsewhere at a designated location, to send an email to designated parties through a wireless or a wired port, to report that it has arrived at a particular destination when it arrives at each location through email or remote control RF signalling means, to unlock a secure cargo upon receiving a code after coming to a certain destination, how to perform requested operation(s) such as: “automatically” or “prompt user” for each operation, in what order to perform them and what to do after it performs them such as to dock there, to lock down and shut down, or to proceed to another location or to go to a series of location(s) and perform additional task(s) or to return to the sending location;
ii) means to provide logic and circuitry with intelligence built-into the automatic-transport system's circuits whereas the system utilizes forward looking and reverse looking sensor(s) whereby it can see obstacles in its path utilizing an algorithm to deviate from its path in memory to go around said obstacle whereas if the obstacle cannot be overcome to proceed around the obstacle and back to the path, the intelligence built into the circuit will provide directions to the automatic-transport system to send it back to its sending location with a programmable message on its display panel (that can be customized) indicating that there was an obstacle in its path that could not be overcome;
iii) means to provide an automatic-transport system in an array of various different models some comprising a model with a steering mechanism in the front of the automatic-transport system and another steering mechanism in the back of the unit so that the automatic-transport system can be steered to follow either a forward or a reverse path in either direction and go forward by switching to the desired steering system or to follow a reverse path on the fly without having to turn around for the convenience to follow a taped or painted line in reverse or to reverse the automatic-transport system's path in a GPS path without having to turn around by just switching from the forward steering system to the opposite reverse steering system and reversing its path direction whereby if it was scanning lines to a destination, it would use its reverse looking scanner sensors to scan for a taped or painted line on the floor or the ground and use the reverse steering system, or whereby if it was using GPS coordinates it would reverse the path in its computer memory and follow the path directions backwards from its location back to its destination; further if it was using operational memory that would drive the automatic transport system's operation via macro(s) then the automatic-transport system would travel forward in reverse using its reverse steering system on its path and follow macro instruction(s) as well and the system would also have the ability to switch back and forth between forward and reverse steering system(s) as it is commanded to do so by the signals it receives;
iv) means to selectively control when and how electromechanical, pneumatic, and or hydraulic electromechanical transfer systems operate to load or unload, secure and hold items, release items, and or to load or to eject items off of platform areas, and or to allow the docking or undocking of lockable and unlockable platform wagon(s) and wheeled pallet(s) and to allow the mechanisms and the automatic-transport system to operate under a variety of modes including automatically as programmed, remotely and or manually under operator intervention upon enterring a security identification code.
